(19) United States
(12) Patent Application Publication
(10) Pub. No.: US 2010/0230339 A1
(43) Pub. Date: Sep. 16, 2010

(54) Particulate chiral separation material

(75) Inventors: Regina Valluzzi, Medford, MA (US); Liya Liu, Boxborough, MA (US); Christopher Sprout, Coventry, RI (US); Benjamin Chaloner-Gill, South Boston, MA (US)

Correspondence Address: WILMERHALE/BOSTON, 60 STATE STREET, BOSTON, MA, 02109, US

(73) Assignee: Evolved Nanomaterial Sciences, Inc., Cambridge, MA (US)

(21) Appl. No.: 11/641,257

(22) Filed: Dec. 19, 2006

Related U.S. Application Data
(60) Provisional application No. 60/785,669, filed on Mar. 24, 2006.
(60) Provisional application No. 60/751,545, filed on Dec. 19, 2005.

(51) Int. Cl. B01D 15/08; B32B 1/00; C07K 1/00

(52) U.S. Cl. 210/198.2; 428/402; 530/353

(57) ABSTRACT

A chiral particulate material and method of making the same are provided. The material includes a fibrous protein or chiral synthetic polymer, optionally crosslinked, organized into a multilayered chiral structure including nanoscale chiral pores or channels. The particles are useful for performing chiral separations, including in chromatographic applications.

### RELATED APPLICATIONS

This application claims priority to U.S. Provisional Application No. 60/751,545, filed Dec. 19, 2005, and U.S. Provisional Application No. 60/785,669, filed Mar. 24, 2006. This application also relates to the U.S. patent application filed on even date herewith, entitled “Production of Chiral Materials Using Crystallization Inhibitors,” which also claims priority to U.S. Provisional Application Nos. 60/751,545 and 60/785,669. The contents of all three of these applications are incorporated by reference herein.

### BACKGROUND

1. Field

The field relates to chiral materials and methods of their manufacture. In particular, the field relates to chiral polymer materials for use in chiral separations.

2. Summary of Related Art

Chiral molecules have application in a variety of industries, including polymers, specialty chemicals, flavors and fragrances, and pharmaceuticals. Many applications in these industries require the isolation and use of single chiral isomers (enantiomers) of chiral compounds. Several methods are commonly used to obtain single enantiomers of chiral compounds. One method is chiral pool synthesis, which involves the use of libraries of chiral starting molecules to create new molecules of interest, while attempting to preserve their chiral centers. Often a “polishing” chiral resolution or separation step is required to provide a product of acceptable enantiomeric purity. A second method is chiral catalysis, which uses chiral catalysts to produce enantiomerically pure compounds. However, matching catalysts and target molecules can be difficult. A third method is chiral crystallization. In some cases, a racemate is complexed with another chiral compound that selects the desired enantiomer, resulting in a chemical distinction between the two enantiomers that allows one to crystallize out. In other cases, a solution is seeded with chiral crystals, causing the desired enantiomer to crystallize out preferentially. However, this approach works only for the approximately 10% of known compounds that crystallize into distinct enantiopure crystallites. A fourth method employs chiral chromatography, such as high performance liquid chromatography (HPLC), which is used in batch mode, or a continuous chromatographic process called simulated moving bed (SMB). SMB involves a number of large chiral HPLC columns run pseudo-continuously in parallel, with fluid inlet and outlet valves along the columns that are switched in a pattern that simulates motion of the solid bed inside the columns. All of these methods present scalability challenges, and no one method is generally applicable throughout scale-up from drug discovery to semi-preparative, pilot and production scale.

As a general matter, chiral recognition and selection of enantiomers is more demanding than most other forms of chemical interaction and recognition. Enantiomers are difficult to separate because they are topologically identical and differ only in their three dimensional geometry by the presence of a subtle “mirror image” symmetry. Thus, all aspects of their chemistry and separatory behavior appear identical except in the presence of a chiral environment, probe or ligand. A widely held theory suggests that for a chirally specific ligand or binding interaction, three separate sites are required per molecule, in order to distinguish the three dimensional nature of the difference between enantiomers. Indeed, most common chiral selector technologies rely on multi-point interactions between an enantiomeric analyte and, e.g., a chiral ligand.

The basic methods of chiral chromatography are HPLC, SFC (supercritical fluid chromatography) and SMB, with simulated moving bed processes employing supercritical fluid mobile phases also under development. All of these chromatographic separations processes can be used for preparative separations, that is, to fractionate and recover enantioenriched or chirally pure fractions from a starting mixture. SFC can be considered along with HPLC and SMB, as a technique that requires some degree of additional engineering to allow HPLC and SMB approaches with supercritical gases as a mobile phase or mobile phase component. The chiral chromatographic materials used in HPLC, SMB and their supercritical fluid analogs are in many cases the same. HPLC tends to be highly engineered and slow, with low capacity and low throughput, employing very small particles of weakly selective, highly chemically specific media. SMB provides higher throughput, but still tends to be highly engineered and costly, with an SMB apparatus typically being designed specifically for each pharmaceutical molecule to be separated at production scale.

In chromatography, a change of column or sorbent allows the system to separate different molecules. For non-chiral chromatography, there are general column types and materials that can address many molecules and sample mixtures to be separated using the same chromatographic material, and often the identical column. For example, reversed phase “C18” columns address the majority of molecules requiring non-chiral chromatographic separations. In these non-chiral approaches, changes in mobile phase composition are typically sufficient to address separation of different types of molecules. In contrast, chiral chromatographic separations use a large number of chiral stationary phases or chiral materials, where each type of chiral material has a much higher specificity and lower generality in the types of chiral molecules it can separate. Even within a class of molecules addressed by a particular chiral stationary phase, there may be individual molecules that can be separated well, marginally, and not at all, with no simple rationale for the success or failure of particular separations. There are some “general purpose” stationary phases for chiral HPLC that can separate a limited variety of compounds. However, specialized stationary phases are needed for a number of common chemical classes (as well as particular compounds within those classes), including acids, free amines, aromatic alcohols, bases, and certain hydrocarbon compounds.

Also, only some of the stationary phases are available as “bonded” media, in which a chiral selector is covalently bonded to silica. In many of the available stationary phases, the chiral selector is simply adsorbed to the silica surface via weak van der Waals interactions, thus limiting compatible solvents to those that will not dissolve off the non-bonded chiral selector. Moreover, bonding a chiral selector can affect its performance, for example, changing the shape of the area used for chiral recognition-based resolution. Thus, improved chiral selectivity, and broader applicability across various types of chiral analytes, of the materials used in the chromatographic stationary phase would be desirable.

There is indirect evidence that the shape of a chiral cavity can be selective for enantiomers by passively containing rather than actively binding the enantiomer. Most of these data come from studies on polymer or molecular imprinting. In these studies, an enantiomer is dissolved in a polymeric matrix, which is then solidified. The enantiomeric “guest” is extracted, leaving behind a polymer with a bias towards chiral cavities in its free volume. These “molecularly imprinted” materials have been found to be selective for enantiomers of the chiral compound used to create them and for closely related chiral molecules. Selectivity is increased when imprinting includes strong chemical interactions between the small molecule guest and the host matrix. The weak and specific selectivity of imprinted polymer materials in the absence of strong chemical interactions between guest and host is expected to be due to the limited flexibility of the polymer chains and the non-chiral free volume within the polymer, which dilute the effect of the chiral volume introduced by an enantiomeric guest species. When strong chemical interactions are introduced, the situation is in effect one where three or more binding sites are available in a small enough volume to recognize a chiral molecule, and the mechanism for selection reduces to the mechanism used in many ligand-functionalized chiral media.

In another chiral selection method, a chirally selective ligand is placed in a confined chiral environment to bias binding in an enantioselective manner. The chirally selective interactions proposed here are chemical and occur in a two dimensional environment (i.e., binding enantiomers by chiral ligands on a surface or ligands on a chiral surface). Clay based chiral selectors have been proposed, based on confinement of chirally selective molecules between partly exfoliated layers of a clay mineral. Thin film deposition of chiral arrangements of copper on a hard surface also has been proposed. Chiral selection using such materials may involve further functionalization of the chiral copper surface with chemical ligands to bind target analyte molecules.

In a few cases, well-defined chiral volumes have been created, for example, molecular scale tubes formed from the intertwined helices of polymer molecules, or chiral carbon nanotubes for potential organization into a membrane. Chiral “zeotypes” (like zeolites), and shape-based mechanisms like enzyme pockets also have been proposed as chiral selectors. Chiral selectivity in all of these cases relies on a close fit between the chiral selector cavity and the chiral analyte that involves a binding interaction. The discrete set of three or more binding sites indicated for typical chiral ligand-based selectivity is replaced by a large number of weaker, less specific van der Waals interactions. These technologies involving well-defined chiral volumes and tight “fits” between chiral analytes and selector cavities are limited in terms of the range of chemical entities that fit into the cavity in a given selector material, thus requiring many different types of selectors to cover a wide range of analytes.

Chirally selective materials potentially useful in chiral separations have been made from protein solutions using templating processes that allow for the formation of a chiral hydrogel at the interface between a hydrophobic liquid and a hydrophilic liquid (see WO 2004/041845, “Templated Native Silk Smectic Gels,” which is incorporated by reference herein). The hydrogels thus formed may have a material superstructure generated by an array of twisting molecules, and may exhibit a long-range ordered structure including layers and/or nanoscale channels. The chiral structure of these hydrogels and dried solids obtained therefrom allows for their potential use as chiral selectors. In these materials, chiral selectivity is linked to the materials morphology, and notable differences in chiral selectivity are observed when the structure of the material is altered.

Furthermore, the templating processes used to form these gels can be cumbersome and labor-intensive, and involve the use of toxic or environmentally unfriendly organic solvents in a constrained environment. Templating is performed in a container that can accommodate the templating liquids, and includes the formation of a still, stable, and cohesive liquid-liquid interface. Accordingly, the shape and format of templated materials is limited, and large scale processing is difficult. Moreover, the interfacial nature of the templating process may generate structures that have channels that are relatively flat, which may affect chiral selectivity. Furthermore, the templated materials exhibit inhomogeneity due to a “core/skin” effect at the interface. A barrier layer forms as a skin on the interface, and then templates into the aqueous polymer solution as bulk hydrogel. The presence of two distinct layers with different properties can cause differences in the material properties at the interface and within the bulk. A “gradient” chiral structure may result, with the material structure varying with distance from the interface. Templated materials also may exhibit levels of chemical stability, swelling in aqueous solvents, and/or purity that could be improved upon for certain applications.

Further improvements in chiral materials and chiral separation performance are desired.

### SUMMARY

Materials and methods are disclosed herein for producing stable and highly selective chiral materials. The materials include, without limitation, substantially uniform, rounded chiral particulates that are well-suited for use in chiral chromatography. Methods also are provided for treating chiral materials to stabilize their chirally selective structure in different chemical environments used in chiral separations. Also disclosed are methods for chemically functionalizing a chirally selective material, e.g., to modify its wettability and chemical affinity characteristics, and thus improve its application-specific performance in chiral separations. Applying these materials and methods, chiral separations are achieved for compounds previously thought difficult or impossible to resolve by liquid chromatography.

One aspect provides a method for producing a chiral particulate material. The method includes exposing a fibrous protein or chiral synthetic polymer to an aqueous solution containing a swelling agent to swell the fibrous protein or chiral synthetic polymer. The swollen fibrous protein or chiral synthetic polymer is annealed in the aqueous solution to obtain a liquid crystalline ordered solid, which has a multilayered structure defining an interlayer region including chiral pores or channels. The swelling agent is removed, and a chiral particulate material is recovered.

In certain embodiments, the chiral pores or channels have a diameter between about 5 nm and about 50 nm. In some embodiments, the fibrous protein or chiral synthetic polymer has an aspect ratio greater than about 3:1. In some embodiments, the chiral particulate material has an aspect ratio of about 2:1 to about 1:1. In some instances annealing is carried out for at least about 4 hours, or for about 1 hour to about 6 hours. In some instances, the chiral particulate material is cured to stabilize the structure of the material. For example, in some cases curing includes heating the particulate material in an aqueous solution or an alcohol solution substantially free of swelling agent for at least about three hours. In some cases, curing is performed for about 3 hours to about 48 hours. In certain embodiments, the chiral particulate material is crosslinked. In some embodiments, the aqueous solvent within the interior of the chiral material is exchanged with a second solvent. In some instances, a catalyst is introduced into the interior of the chiral material.

Another aspect provides a chiral separations column containing closely packed particles of a fibrous protein liquid crystalline ordered solid having a multilayered structure. Each layer of the multilayered structure includes a molecularly oriented fibrous protein, and the layers define an interlayer region including chiral pores or channels. The chiral pores or channels are selective to one chiral orientation and have a diameter between about 5 nm and about 50 nm.

In some embodiments, the particles are substantially uniform, rounded particles. In some instances, the particles have a size of about 5 microns to about 25 microns. In certain embodiments, the column provides a separation efficiency greater than about 10% EE. In some embodiments, the particles are crosslinked. In some instances, the particles are swollen in a solvent.

Another aspect provides a chiral particulate material including substantially uniform rounded particles of a fibrous protein liquid crystalline ordered solid having a multilayered structure. Each layer of the multilayered structure includes a molecularly oriented fibrous protein, and the layers define an interlayer region including chiral pores or channels having a diameter between about 5 nm and about 50 nm.

In some embodiments, the material is crosslinked. In certain embodiments, the crosslink comprises about 1 wt % to about 20 wt %, for example, about 5 wt %, of the chiral material. In some instances, the crosslink density is selected to reduce swelling of the particulate material in water. In certain embodiments, the accessible surface area of the material possesses a chiral submicron texture. A separations column containing particles of the material is also provided.

Yet another aspect provides a chiral HPLC column capable of producing baseline resolution chromatographs for enantiomers of one or more of 2-heptanol, 2-methyl-1-butanol, 2-pentanol, 2-butanol, 2-amino-1-butanol, 2-amino-1-pentanol, 3-butyn-2-ol, phellandrene, fluoxetine, thalidomide, alkaloids and terpenes. In some embodiments, the column is capable of resolving structural isomers and/or diastereomers of such compounds. In some embodiments, the column is capable of resolving enantiomers having multiple chiral centers.

### BRIEF DESCRIPTION OF THE DRAWING

The following figures are presented for the purpose of illustration only, and are not intended to be limiting.

FIG. 1 is a flow chart illustrating the treatment of a chiral material according to one or more embodiments.

FIG. 2 is a plot of the rotation of light versus pH for a chiral silk material.

FIG. 3 is a plot of light rotation for a chiral silk material with different load percentages of poly(propylene glycol) diglycidyl ether (PGDE, CL-1) crosslinking agent.

FIG. 4 is a plot of light rotation versus pH for a chiral material prepared using different loads of crosslinking agent under different pH conditions.

FIG. 5 shows Fourier transform infrared (FTIR) spectra of chiral materials prepared using 0%, 5%, 10%, 15% and 20% by weight crosslinking agent.

FIG. 6 is an HPLC elution trace for thalidomide using a separations column employing a chiral protein powder according to one or more embodiments. Separation of the enantiomers is clearly shown.

FIG. 7 is an HPLC elution trace for sec-butyl acetate using a separations column employing a chiral protein powder according to one or more embodiments. Separation of the enantiomers is clearly shown.

FIG. 8 is an HPLC elution trace for 2-methyl-1-butanol using a separations column employing a chiral protein powder according to one or more embodiments. Separation of the enantiomers is clearly shown.

FIG. 9 is an HPLC elution trace for 2-heptanol using a separations column employing a chiral protein powder according to one or more embodiments. Separation of the enantiomers is clearly shown.

FIG. 10 is an HPLC elution trace for 2-methyl-butanol using a separations column employing a chiral protein powder according to one or more embodiments. Separation of the enantiomers is clearly shown.

FIG. 11 is an HPLC elution trace for clenbuterol using a separations column employing a chiral protein powder according to one or more embodiments. Separation of the enantiomers is clearly shown.

FIG. 12 is an HPLC elution trace for α-methyl benzylamine using a separations column employing a chiral protein powder according to one or more embodiments. Separation of the enantiomers is clearly shown.

FIG. 13 is a plot of column pressure versus flow rate comparing columns packed with particles smaller than 25 microns of 5 wt % crosslinked and uncrosslinked chirally selective material.

FIG. 14 is a plot of rotation versus time for separations of 3-butyn-2-ol and 1-hexyn-3-ol.

FIG. 15 is a plot of enantiomeric excess (EE) % obtained using different percentages of water versus ethanol in the solvent system for a batch sorbent separation of α-methyl benzylamine.

FIG. 16 is a plot illustrating the effect of buffer in the solvent system on the batch sorbent separation of α-methyl benzylamine.

FIG. 17 is a plot illustrating the effect of multiple stages on the enantiomeric purity of α-methyl benzylamine obtained from a batch sorbent separation.

FIG. 18 is a plot illustrating the effect of water content of an ethanol/water solution on the batch separation of 3-butyn-2-ol.

### DETAILED DESCRIPTION

Chirally selective materials, methods of making these materials, and methods of using them to perform chiral separations are disclosed herein. Certain embodiments provide highly chirally selective separations media that are useful for separating a broad range of chiral molecules in chromatography and other applications. The chiral materials according to one or more embodiments are about 10,000 times to 100,000 times as chirally selective as currently-available media and materials. Typical existing media provide only weak chiral selectivity. In contrast, media and materials according to one or more embodiments herein offer at least about 15% enantiomeric excess (EE) per separation stage. Enantiomeric excess can be represented by the absolute value of the difference in moles of two enantiomers present in a sample divided by the total moles of both enantiomers in the sample, i.e., (|moles A−moles B|/(moles A+moles B))×100% for a sample containing enantiomers A and B.

### Particulate Chirally Selective Materials

One aspect provides particulate materials suitable for use in chiral separations, such as chiral chromatography or batch sorbent separations. In certain embodiments, a chirally selective material is provided in the form of substantially uniform rounded particles made from a polymer such as a chiral synthetic polymer or fibrous protein, e.g., a protein or synthetic polymer that forms fibers or fibrils. In at least some embodiments, the rounded particles are formed directly by the processing method of making the material, as opposed to being ground from a larger mass of material. In at least some instances, the substantially uniform, rounded nature of these directly formed particles distinguishes them from more polydisperse, inhomogeneous or asymmetrical particles that are produced by mechanical grinding processes. A powder containing the substantially uniform, rounded particles provides good packing and flow characteristics that are well-suited for preparing chromatography columns, for example, for use in chiral HPLC separations.

In at least some embodiments, chiral materials as described herein are made from polymers having a sufficient quantity of chiral subunits or monomers, enriched for one enantiomer, that they will form a chiral secondary structure (e.g., a helix) in the crystalline phase, will interact with other chiral phases in solution, and will have sufficient orientation to form chiral domains. In certain embodiments, the polymer includes at least about 30%, for example, at least about 40%, at least about 50%, at least about 60%, at least about 70%, or substantially 100% chiral monomers of a single orientation.

Suitable raw materials for making the present chiral materials include without limitation natural fibrous proteins, proteins and polypeptides derived from such proteins, and biosynthetic materials having sequences derived from such proteins. Suitable fibrous proteins include, but are not limited to, collagens, keratins, chorions, actins, fibrinogens, fibronectins and silks, as described in more detail below. Other biological polymers, such as sugars, cellulose derivatives and other helical or simple chiral rigid molecular structures also are expected to form interpenetrating chiral layered phases, giving rise to chiral channels. Further useful raw materials include synthetic polypeptides and peptides with patterns of amino acids as described in WO03/056297, entitled “Self-Assembling Polymers, and Materials Fabricated Therefrom,” which is incorporated herein by reference.

In some embodiments, raw materials include the general class of “elastomeric proteins.” These proteins occur in muscles, connective tissues and blood vessels of vertebrates, in bivalve mollusks as attachment proteins, in spider and insect silks, and in wheat seeds. They exhibit a number of common features, such as regular structures (e.g., dominant secondary structure motifs, supermolecular helical arrangements of secondary structures, molecules, or fibers in a tissue, extracellular material, extra-organism material, or intracellular structural material). Non-limiting examples of useful raw materials include the fibrous proteins collagens, FACIT collagens, mammal collagens, invertebrate collagens, sea sponge collagen, sea cucumber collagen, elastin, resilin and keratins. Synthetic molecules incorporating such fibrous protein sequences and patterns are also useful.

Isolation and processing of some fibrous proteins is facilitated because they occur as extracellular matrix proteins, or even are found outside of organisms, for example, invertebrates. Non-limiting examples of suitable extracellular proteins include silk, collagen, resilin, keratin and elastin. In certain embodiments, in addition to proteins such as collagens, elastins, and resilins extracted from invertebrates, extracellular proteins such as silks are obtained from, for example, cocoons, egg casings, dragline, or webs. Examples of natural silk types include without limitation spider dragline silks, spider capture silks, spider cribbelate silks, spider anchor silks, spider web silks, insect cocoon silks, and insect and spider egg casing silks. Major silk producing organisms include spiders, embiids (embiidina), larvae of moths and butterflies (Hymenoptera and Lepidoptera), flies, bees, and wasps.

In some embodiments, various silks, collagens, and other fibrous proteins from the nine orders of Arachnida are used. Non-limiting examples of Arachnida that possess multiple forms of silk obtainable in useful quantities include the following: jumping spiders (family Salticidae, sometimes called salticids), crab spiders (e.g., Misumenoides), golden silk spider (Nephila clavipes), spiny orb-weaver (Gasteracantha cancriformis), argiope spiders (e.g., Argiope aurantia), green lynx spider (Peucetia viridans), wolf spiders (family Lycosidae, e.g., Lycosa carolinensis), long-jawed orb-weavers (genus Tetragnatha).

Further non-limiting examples of silk-producing genera, families, and specific organisms include the following: Aranea, Nephila, Antherea, Bombyx, Argemia, Gonometa, Borocera, Anaphe, Tetragnathidae, Agelenidae, Pholcidae, Theridiidae, Deinopidae, Meteorinae (Hymenoptera, Braconidae), Embiidina, Tropical Tarsar Silkworm Anthereae, Eri Silkworm, Samia recini, Philosamia ricini, Antheraea assama, Nang-Lai, Satumiidae, Antheraea periya, B. mandarina, Antheraea mylitta (Doory), Antheraea Asamensis Helfer, cocoons of the parasitic wasp Cotesia (Apanteles) glomerata, Antheraea yamamai, Callosamia (Saturniidae), Hemileuca grotei (Saturniidae), Anisota (Saturniidae), Schinia, Hemileuca (Lepidoptera, Saturniidae), genera Actias, Citheronia (Saturniidae) and subfamily Euteliinae (Noctuidae), Hemileuca maia complex (Saturniidae), Arsenurinae (Saturniidae), Agapema (Lepidoptera, Saturniidae), Attacus mcmulleni (Saturniidae), Lasiocampidae (Lepidoptera), Attacus Caesar, Anisota leucostygma, Cricula trifenestrata, Natronomonas pharaonis, Sphingicampa Montana, Pygarctia roseicapitis, Leucanopsis lurida, Hemileuca hualapai, Hemihyalea edwardsi, Grammia geneura, Eupackardia calleta (wild silkmoth), Automeris patagoniensis, Automeris cecrops pamina, and Antherea oculea.

While many of the embodiments herein are described with reference to fibrous proteins, and specifically illustrated with reference to silk-based proteins, the methods and compositions described herein are not so limited, and are applicable with respect to other raw materials including fibrous proteins or synthetic polymers. The chiral nature of the raw material polymer plays a role in the molecular configuration and the molecular superstructure of the resultant chiral material made as described herein. The chiral material formed from the polymer is chirally selective, i.e., capable of distinguishing between and preferentially interacting with one of two enantiomers of the same compound. In contrast, the source polymer, while containing chiral molecules, typically demonstrates no measurable chiral selectivity, or is only poorly selective. These and other features of the physical and optical properties of the chiral materials according to one or more embodiments reflect the changes in the solid state arrangements of the material that occur upon processing a polymer as described herein.

In some embodiments, the chirally selective particulate material includes particles having a size less than about 25 μm, for example, in the range of about 5 μm to about 25 μm, or about 10 μm to about 25 μm. Particle size is determined, for example, by electron microscopy or analytical sieving. In some embodiments, the particles are substantially uniform, rounded particles. Such particles are useful, for example, in packed chromatography columns. However, in various embodiments, the particles have a variety of shapes, including spheroidal, elongated or needle-shaped, toroidal, lobed, square, or trapezoidal. The aspect ratio typically is less than that of the source polymer (which may naturally assume an aspected structure, e.g., having an aspect ratio greater than about 3), for example, about 2:1 to about 1:1. In some instances, porosity is increased compared to the source polymer. In one or more embodiments, the particles consist of rolled or crumpled sheets. The sheets possess a chiral surface texture, and in some instances are interconnected.

### Chirally Selective Materials Structure

In one or more embodiments, chirally selective materials are provided whose structure is based on the chiral liquid crystalline phase of chiral synthetic polymers or fibrous proteins. Such polymers form chiral liquid crystals in concentrated solution where layers of molecules are formed. The layers of molecules attempt to twist, and the molecules themselves within the layers simultaneously twist, in a manner that is not compatible with long range order in distinct layers. The result is an interpenetrating network of twisted polymer layers and solvent-filled pores or channels. This interpenetrating network incorporates a chiral twist because the underlying polymer is chiral. The resultant materials have a high internal surface area consisting of chiral pores or channels, and provide good chiral selectivity for chiral separations.

In certain embodiments, protein and polymer particles of substantially uniform, low aspect size are made of discrete stacks of protein layers. Wrinkling and perforations of these layers, combined with chiral interactions giving rise to a tendency for the layers to twist, result in regular microscale patterned surface textures. Fibrous proteins (and synthetic polymers designed on their structure) typically consist of large chiral self-fabricating units, and smaller solubilizing functional ends. The thermodynamically favorable state of the entire molecule is similar to the thermodynamically favorable state for the self-fabricating block. Protein fibers tend to arrange in smectic or hexatic liquid crystal-like phases.

In a molecular packing geometry dominated by interactions between smectic phase-forming self-fabricating blocks, the local packing in regions containing end chains (“end blocks”) often is highly strained, because the ideal thermodynamically favored geometry for the end blocks is not compatible with the packing favored by the self-fabricating blocks. The end blocks are forced into a state that is far from their local thermodynamic ideal, and are “frustrated.” Frustrated smectically ordered solids result, in which the density and interaction behavior in interlayer regions are strongly perturbed with respect to the bulk material, or non-frustrated surfaces, of the same composition.

In one or more embodiments, the materials have a high internal surface area consisting of chiral pores or channels. Within a chiral channel or set of chiral interconnected pores, molecules transported through the channel, through convection, capillarity, diffusion or another mechanism, will interact frequently with the walls of the channel or interconnected system of pores. If the diameter of the channel or interconnected system of pores is similar to the molecule (1×-2×), the interactions between the molecule and the solid walls hinder certain aspects of the molecule's motion, and effectively hinder diffusion of the molecule or exclude it from the pores or channels. If the channel diameter or pore diameter is much larger than the molecule (>50×-100×) the chemistry and shape of the walls make a very minor contribution to the transport of molecules within the pore system or channels. However, for pores or channels with a diameter a few times to roughly an order of magnitude larger than a molecule (4×-60×), there typically is significant interaction between the molecule and the walls of the channel or pore, without significant barriers to diffusion. In this range of pore and channel sizes (i.e., diameters), a great deal of chiral interaction occurs between a solute and any chiral molecules, voids or structures within the surface of the material for every few Angstroms of diffusion. Furthermore, the curvature of the pore or channel walls and the chiral aspects of that curvature are at a length scale where physical interactions between the analyte and the wall involving, for example, transfer of angular momentum, configurational entropy of the analyte near the wall, and other similar interactions, become meaningful and significantly different for molecules with differing chiral symmetry. Without being bound by any particular theory, even non-specific interactions are expected to be chirally selective for diffusion of enantiomers through the material's pore or channel architecture. The large surface area provided by the material nanostructure for interactions provides high selectivity, and the possibility of a largely entropy-driven diffusion and interaction process ensures that separation is not specific to a particular well-matched solute-end block pair. See WO 2004/041845, which is incorporated by reference, for further details regarding this type of mechanism.

In certain embodiments, chiral materials prepared as described herein include one or more of the following features. In at least some instances, the chiral materials have a robust smectic layer formation. Molecules are arranged locally in a chiral smectic or hexatic phase. Molecules have a long direction, and the long directions of molecules in a small local area of matter are oriented in the same direction (smectic, and not isotropic). Distribution of orientations is less broad than in nematic, cholesteric, or “blue phase” liquid crystals. The chiral material also includes molecules that are locally arranged in layers or bilayers. There can be locally regular packing within layers, although fluidity or plasticity is maintained. In at least some instances, functional blocks are used to localize solute in the interlayer region (enthalpically or entropically). Chiral functional blocks form nanoscale chiral pores or channels that provide a high surface area of interaction. There is sufficient structure and density in the material to prevent non-specific diffusion (smectic or higher order, and density comparable to a homopolymer or greater). In certain embodiments, the chiral material exhibits chemical compatibility with a solute, and a solvent for the solute. In at least some instances, the material swells in the solvent to promote solvent diffusion, but does not dissolve. Swelling typically is limited to less than about a 50% increase in the volume of the endblocks (e.g., if the endblocks make up 20% of the material, swelling is not more than about 10%).

### Mechanism of Chiral Separation

Chirally selective materials made as described herein are suitable for use as chiral selectors in wet or dried form. Materials made according to one or more embodiments provide a general mechanism for chiral separation that is independent of the chemistry of the enantiomers being separated (aside from typical separations physical chemistry factors, such as solvent wetting and solute partitioning). Typically conventional chiral materials are applicable to only a limited range of analytes because they rely on a chiral surface, cavity or volume of a similar size-scale to the molecules being selected, as well as close contact and specific interaction between the chiral molecule and the selector matrix at multiple contact points, to effect separation. In contrast, chiral selectivity is observed in the chirally selective materials according to one or more embodiments even in the absence of a ligand interaction, other binding interaction, or even a chemical affinity for the material containing the chiral pores or channels.

In certain embodiments, materials made as described herein are modified through chemical functionalization. In at least some instances, the materials retain their chiral selectivity even when functionalized with non-chiral moieties, again demonstrating that the chiral selection mechanism is based on the material structure, rather than typical chemical/molecular level interactions. Chemical interactions based on the added non-chiral moieties act in addition to the chiral selection mechanism.

While not to be bound by any particular theory, materials produced according to one or more embodiments herein may perform chiral separation via a chiral exclusion mechanism, in which molecules of a selected chiral orientation are excluded from the internal chiral volumes of the chirally selective material. Chiral sorting is driven by entropy and selective diffusion into and through interconnected pores and channels of the chiral material. In at least some embodiments, the microstructure of the material provides a high surface area, controlled size distribution of materials features, and high interconnectivity to facilitate diffusion. The shape of the material's microstructure and nanostructure, defined at the supermolecular level, allows one enantiomer to enter more easily and spend a longer time in the pores and channels compared to the corresponding enantiomer of opposite handedness. One enantiomer is thus preferentially retained in the chiral pores or channels, while the enantiomer of opposite handedness passes through the material more quickly. In at least some instances, the chiral pores or channels are well-defined and the material lacks significant free volume accessible by non-chiral molecules, thereby improving selectivity. The tendency of the chirally selective materials to exhibit chiral exclusion may be exploited in column chromatography, extraction and filtration processes.

An exact or tight fit is not required between the shape and size of enantiomers of molecules to be separated, and that of the chiral pores or channels in the separating material. Rather, the chiral pores or channels of the separating material may be somewhat larger than the enantiomers to be separated. Even without a very close match of shape and size, molecules having the same chirality as the pores or channels preferentially explore the pores or channels, and statistically take longer to pass through the separating material than molecules having the opposite chirality. However, the chiral pores or channels are not so large that any sense of chirality is lost to the chiral molecules passing through. In certain embodiments, chiral pores or channels having a diameter less than about 50 times the size of the chiral molecules to be separated are utilized. For example, the pores or channels are less than about 40 times, about 30 times, about 20 times, about 10 times, or about 5 times the size of the chiral molecules to be separated. Such chiral pores or channels having a volume of sufficient size to interact with chiral molecules, allowing separation of one enantiomer from another, are referred to herein as a “chiral volume.” In certain embodiments, the pores or channels have diameters between about 4 and about 60 times, for example, between about 20 and about 50 times the size of a chiral molecule to be separated. In some embodiments, the size (i.e., diameter) of the chiral pores or channels is between about 5 nm and about 50 nm, for example, between about 5 nm and about 30 nm, whereas many enantiomers to be separated are smaller than about 1 nm. Pore or channel diameter can be determined by field emission scanning electron microscope (SEM) examination.

### Preparation of Chirally Selective Material

In certain embodiments, particles of chirally selective material are prepared by heat annealing a fibrous protein in an aqueous solution containing a swelling or softening agent. In certain embodiments, conditions are selected such that fine particles are formed. In at least some embodiments, uniform rounded particles are provided. Sufficient swelling solution is provided to wet the raw material; however, protein load is not critical. Swelling of the natural fiber allows rearrangement of the molecules in the fibrous protein nanostructure, which in many cases is already in a molecular arrangement that is close to the desired structure for chirally selective materials. Accordingly, minor rearrangement of the protein molecules achieves a desired configuration. Using an appropriate annealing temperature and swelling agent, as described below, the ordered domains in the protein fiber are driven into a chiral structure suitable for chiral separating materials. The fibrous protein forms a well-ordered molecular structure, with protein molecules aligning with their neighbors to produce a stable material. However, because the fibrous protein is only swollen in the aqueous solution, the original protein configuration is not lost entirely, as would be the case when a protein is fully dissolved.

Non-limiting examples of swelling agents include simple salts of Group I metals, e.g., Li, Na and K; Group II metals, e.g., Mg and Ca; and ammonium salts. Simple salts include, without limitation, chlorides, iodides, bromides, nitrates (NO₃), carbonates, bicarbonates and acetates. These salts or other swelling agents in the appropriate concentration render the aqueous salt solution a “poor solvent” for the fibrous protein, so that the polymer swells without fully dissolving. Exemplary swelling agent concentrations range up to about 2 M. However, the amount used varies depending on the particular swelling agent and protein system. In at least some embodiments, the swelling solution is a “poor solvent” (as understood by those skilled in the art of polymer science). However, in certain instances, adding more swelling agent changes an aqueous solution into a “good solvent,” such that a protein solution is attained.

The annealing mixture is heated above ambient temperature, but below the temperature at which the protein is denatured (or, for a polymer, reaches the glass transition temperature or melting temperature). Typical annealing temperatures for fibrous proteins range up to about 90-95° C. Annealing is conducted for a time sufficient to swell the protein structure enough to disrupt the existing molecular configuration (typically crystalline β-sheets) so that rearrangement can occur. Exemplary annealing times range from about one hour to about 24 hours, for example, about 2 hours to about 12 hours, or about 4 hours or more.

By heating the swollen polymer, the desired configuration for the chirally selective material is formed. After heating, the material is cooled, and the polymer is locked into the desired configuration, typically forming particles. Without being bound by any particular theory, it is believed that rounded or other low aspect particle shapes form upon cooling (instead of fibrils more consistent with the source material) because the polymer seeks to avoid loss of ordered nanodomains that can arise over long distances. Formation of particles naturally limits the nanodomains and retains the desired chiral nanostructure.

In certain embodiments, an additive is included in the aqueous solution that affects the assembly process, for example, a plasticizer to reduce polymer crystallinity, or a precipitation agent. In one or more embodiments, an acidic agent is added to discourage excessive crystallization and promote solvation of the fibrous protein. Exemplary acidic additives include, without limitation, acetic acid, formic acid, hydrochloric acid, phosphoric acid, trifluoroacetic acid, sulfuric acid, nitric acid, and Lewis acids, such as AlCl₃ and FeCl₃. Without being bound by any particular theory, it is believed that acidic additives tend to discourage the formation of hydrogen bonds, and thereby discourage crystallization.

In various embodiments, the morphology and microstructure of the chiral materials produced is controlled by choice and concentration of swelling agent; environmental factors, such as temperature and humidity; and/or modifications to the solvent, e.g., addition of ether, alcohol, and/or acid to the swelling solution. Altering these parameters affects the permeation properties, molecular orientations, and surface topographies of the resultant chiral materials.

In one or more embodiments, clean silk fibers are immersed in water and heated to, e.g., 90-95° C. A swelling agent such as NaCl is added to soften or swell the fibers. The fibers are held in the swelling solution for about one hour to about 6 hours, for example, at least about 4 hours. The polymer is then rinsed to remove salt solution, and dried to provide a particulate material. Drying typically is accomplished using conventional methods, such as air drying, drying under a vacuum, lyophilizing, or combinations thereof. The drying temperature is a function of residual water content. As the water content is reduced, the particles of chiral material are stable at higher temperatures.

### Further Processing of Chirally Selective Material

In one or more embodiments, particles of chiral material are washed to remove swelling agent, and then cured in a curing solvent to stabilize the particle structure and increase chiral selectivity. Curing is carried out for at least about 1 hour, for example, at least about 3 hours, at least about 6 hours, or up to about 3 days. Curing typically occurs at slightly elevated temperatures, e.g., about 15° C. to about 30° C., in an aqueous or organic solvent after removal of the salt solution. In one or more embodiments, the curing solvent is selected to wet the particulate material. In some embodiments, the solvent is an alcohol. Exemplary solvents include, without limitation, water, ethanol, methanol, 1-propanol, 2-propanol, ether, acetone, tetrahydrofuran, citric acid, acetic acid, lactic acid, malic acid, aqueous sucrose, aqueous glucose, aqueous fructose, aqueous mannose, aqueous dextrose, hexane, pentane, heptane, octane and acetonitrile.

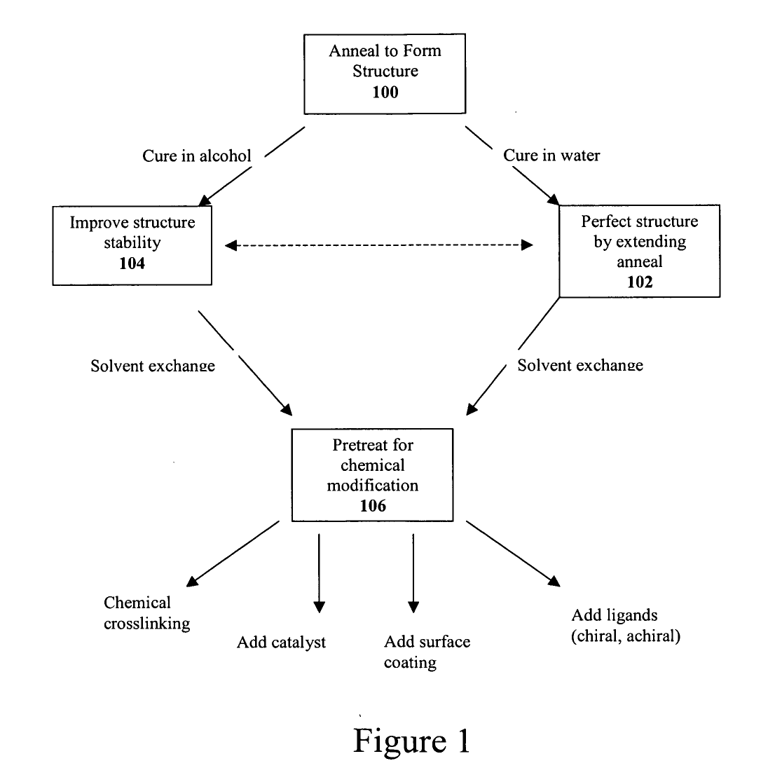

Curing typically is performed to accomplish one or more objectives as set forth in FIG. 1. Process box 100 represents annealing of a polymer fiber, as described above. In some instances, as shown in process box 102, the fiber is then cured in water for several hours or days, to improve or perfect the structure formed from the fiber during annealing. This curing, as an extension of annealing, serves to remove stray impurity molecules and reduce defects. Alternatively, or additionally, the fiber is cured in an alcohol, such as the ones listed above, as shown in process box 104. Alcohols do not solvate proteins well, and can promote localized crystallization, such as localized β-sheet formation. The resultant localized regions of closer polymer intrachain or interchain interaction serve as effective physical crosslinkers, which lock in and stabilize the material nanostructure.

In some instances, a chiral material processed according to process 102 or 104 is further treated to exchange the solvent in the structure interior, typically in preparation for further chemical modifications, or to prepare the material for use in chiral separation (see process box 106). The inherent chemical properties of the material drive wetting, sorption, chemical partitioning, and capillarity, and can be modified through chemical functionalization. These familiar chemical interactions and effects can act independently of the chiral selection mechanism afforded by the chiral volumes of the material. By way of non-limiting example, in various embodiments chemical functionalization is used to introduce chemical compatibility with particular compounds, chemically or chirally selective ligands, particular adsorption properties, or mechanical, thermal or chemical stability, or to modify pore or channel structure or size. For example, in some instances chemical modification agents are used to make the material hydrophobic, to make the material attractive to halogen or sulfur, or to coat the material with a silane compound. Exemplary chemical modifications include, without limitation, chemical crosslinking of the polymer, addition of a catalyst (for example, for conducting chiral catalysis of organic reactions), addition of a surface coating (for example, hexamethyldisilane (HMDS) siliconization, or other coatings to alter surface sorptive properties), or addition of chiral or achiral ligands. Suitable chemical modification agents include, but are not limited to, silanizing agents, crosslinkers, hydrophobic coating agents, coupling agents and the like. In some instances, the chemical modification agent is added in the presence of a solvent in an incubator. In at least some embodiments, the chirally selective material is incubated with the chemical modification agent at a temperature that promotes reaction with the modification agent. Typically, the incubation temperature does not exceed about 70° C. Following incubation, in at least some embodiments, the material is washed in water, alcohol or another solvent to remove excess chemical modification agent.

In one or more embodiments, the chiral material is stabilized using physical or chemical crosslinks. Crosslinking tends to stabilize the material nanostructure and control the extent of swelling of the chiral material in water or other solvent. For protein-based chiral materials, reactive groups include OH, NH₂ and COOH. These groups allow for condensation polymerization, and include formation of glycidyl ethers. For condensation, anhydrides, di-, tri-, and multifunctional-acids, di-, tri-, and multifunctional-amines, amino alcohols, di-ols, glycols, di-, tri- and multifunctional glycidyl ethers, di-, tri-, and polyfunctional epoxides and sulfoxides, and molecules having combinations of two or more reactive functional groups are all useful crosslinking agents. Crosslinking is not limited to di-functional groups. In some instances, tri- and tetra-functional crosslinking agents are used as well. The higher the number of potential crosslinking groups, the higher the crosslink density, often imparting areas of “hardness” relative to other areas. In some cases, within a di- or multi-functional crosslinking agent, the bridge between active moieties is different. In some embodiments, a non-symmetrical crosslinking agent is employed, for example, a glycidyl ether on one end and an acrylate on the other, or a monoacrylate with a functional group that can condense on the other end. If a non-symmetric material is chosen with an acrylate, addition polymerization is made possible. In some embodiments, groups are attached to the molecules that do not participate in crosslinking reactions, but that do alter the surface chemistry of the chiral material. For example, a molecule with di-, tri-, or polyfunctional glycidyl ether functionality can also have alkane sequences connecting the crosslinking diglycidyl ether functions, which impart hydrophobic alkene character to the chiral materials surface once the molecule is crosslinked onto the surface. Similarly, a pendant alkane or other functionality, present as a side chain or side group and not attached at both ends to atoms bonded to the crosslinking groups, can be used to impart hydrophobic C8, C18, or other typical “reversed phase” HPLC chemistries to the surface of the chiral materials. In some embodiments, inorganic crosslinking agents are used, such as, for example, boric acid, phosphorous compounds, and sulfur compounds.

In some embodiments, the interior volumes of a chiral material are coated with a substance that promotes favorable interactions with particular types of chiral molecules to be separated.

### Applications

Chiral materials prepared according to one or more embodiments herein are useful as chiral selectors in wet, dried or liquid crystalline format. Chiral separations applications include, without limitation, chiral sorbents, chromatography media, filters and sensors. In certain embodiments, chiral enantiomers are separated by diffusing a mixture of enantiomers into a chirally selective material in solution. One enantiomer preferentially explores the interior of the material, while another enantiomer tends to be excluded from the material. The material is removed from the solution and rinsed to remove the excluded enantiomer from the material surface. The enantiomer that preferentially explored the interior of the material is removed by solvent extraction. In some instances, the chirally selective material is used to “sponge up” one enantiomer, leaving another enantiomer behind. In some instances, the chirally selective material is formed into a filter, which allows one enantiomer to pass through, while retaining another enantiomer.

In some embodiments, a chirally selective material made as described herein provides greater than about 10% EE in a single separation step. Enantiomeric excesses greater than about 20%, about 30%, about 40%, and about 50% have been observed in a single step. High EE also been observed. In some instances, materials scoring at least about 50% EE on the chiral selectivity test described in Example 4 below have been found useful for chiral HPLC separation.

Materials made as described in one or more embodiments herein are useful in various chromatography applications, including low to moderate pressure liquid chromatography (LC), flash LC, affinity LC, and HPLC. Supercritical fluid separations also are made possible. In certain embodiments, a substantially uniform, rounded particulate chirally selective material provides good flow and packing properties for use in a chromatography column. In various embodiments, the chromatography columns are operated in isocratic, gradient, reverse phase, or ion-affinity mode. The columns are suitable for use with aqueous and non-aqueous solvents.

Chirally selective material according to one or more embodiments is prepared in the form of substantially uniform, rounded particles, which are well-suited for packing in chromatography columns. As demonstrated in the Examples below, columns packed with the material perform well, and HPLC separations have been observed for chemical classes previously thought unaddressable by liquid chromatography. In general, small compounds with molecular weights less than 300, molecules with strong amine groups, and molecules with chiral centers “buried” behind sterically hindered or fatty side chains previously have been difficult or impossible to separate through liquid chromatography. Examples of compounds for which it is believed that HPLC separation had not been obtained previously include sec-butyl acetate, 3-butyn-2-ol, 1-hexyn-3-ol, and 2-methyl-butanol. Chiral separation of these compounds has now demonstrated.

HPLC columns made from chirally selective material according to one or more embodiments herein provide excellent selectivity, purity, yield and throughput. These chiral HPLC columns also advantageously provide improved capacity compared to currently available HPLC columns. Based on this improved chiral performance, chiral materials prepared according to one or more embodiments herein are suitable for use in a filter cartridge for a combinatorial chemistry system that produces enantiomers as an integrated part of automated combinatorial drug discovery and screening.

In some embodiments, a powder of chirally selective particulate material is packed into an HPLC column. The solvent system for HPLC is chosen based on the analyte, according to standard methods known to those skilled in the art. In some instances, the material is crosslinked prior to packing to promote water stability. In some instances, the material is coated with a hydrophobic layer (e.g., silane coupling agents such as hexamethyldisilane (HMDS)) to provide stability against swelling by water and to promote hydrophobic reverse phase interactions.

In some embodiments, an HPLC column is packed with particles of chirally selective medium that are between about 5 μm and about 25 μm, or particles that are about 25 μm or smaller (no fine particle cut-off). By way of non-limiting example, in certain embodiments, a column is packed as follows. The chirally selective material is slurried using isopropanol and/or hexane. The slurry is pumped into a column, or into a precolumn reservoir, which is then connected to an empty column casing. In some embodiments, the column is between about 2.5 cm and about 25 cm long, and between about 0.5 mm and about 2 cm in diameter (inner diameter). If an air gap results on packing the column, in some instances it is left (e.g., for use in water-based systems), and in other cases it is filled with additional chirally selective material to achieve a tight packing (e.g., for use in non-water-based systems). Once the column is full, it is sealed for use, e.g., in normal phase HPLC. In certain embodiments, chirally selective media from used columns is regenerated by swelling, washing and then de-swelling it for reuse.

The chromatographic systems are adjustable to cause either enantiomer of a chiral compound to elute first, depending on the solvent system used as a mobile phase in the separation. Solvents that swell the material often reverse the elution order compared to solvents that do not swell the material. Strong polar and electrostatic chemical interactions are effectively screened in non-swelling solvents, allowing the shape interaction to dominate chiral selectivity. In contrast, shape interaction is weakened in swelling solvents, where polar, electrostatic and H-bonding interactions are stronger and tend to dominate. Solvent-based elution order reversal is possible because of the generality of the chiral selection mechanism(s) provided by the material.

Since chiral chromatographic separation using materials as described herein can be obtained across a range of solvents and solvent systems, varying the solvent composition provides a rich landscape of chirally selective behaviors. In addition to standard chiral separations, the systems are suitable for carrying out chemical separations, separation of achiral stereoisomers, and multi-component separations, including simultaneous resolution of multiple chiral isomers and their enantiomers and/or achiral stereoisomers and/or chemically closely related species. In certain embodiments, the columns are used to simultaneously separate several different compounds, each of which is present as a mixture of isomers. Each enantiomer and/or stereoisomer of each compound elutes separately. Typically, the isomers of one compound elute separately, followed by separate elution of the isomers of another compound. Chromatographic separations using the chirally selective materials made as described in one or more embodiments herein generally are performed with an analyte on the gram or milligram scale.

In some embodiments, rather than (or in addition to) adjusting the solvent system, the chiral material itself is chemically functionalized to accommodate various modes of separation and/or improve interaction with particular chiral molecules to be separated. Examples of chemical functionalization are described above. For example, in at least some instances the chiral material includes ionic groups. Accordingly, when it is desired to perform a separation under non-ionic conditions, either the ionic groups are reacted off of the surface of the chiral material, or the material is used under solvent conditions that do not support ionization.

In other embodiments, finely divided particles of the chiral material, in either swollen or dried form, are used as an additive or filler in coatings or polymeric materials. The particles of chiral material make the polymers and coatings chirally selective. For example, in certain embodiments, a chirally selective filled polymer is created. In some instances, a polymer is selected that dissolves in a solvent that swells the particles of chiral material, but does not dissolve them. Alternatively, a polymer is used that dissolves in a solvent that wets the particles of chiral material, but does not substantially swell them. The polymer has sufficiently high molecular weight that it is too big to substantially block the chiral pores or channels of the particles of chiral material. Typically, the polymer has a radius of gyration greater than about 50% of the pore or channel diameter of the particles of chiral material. The radius of gyration is determined for the solvent to be employed, using either published values, or well-accepted experimental techniques, such as dynamic light scattering and static light scattering Zimm plots, gel permeation chromatography, or high frequency low strain dynamic mechanical rheological measurements. Statistical measures of polymer radius of gyration as a function of polymer length (molecular weight), polymer chemistry, and solvent are well known in the art, and can be found, for example, in Polymer Handbook (Brandup, Immergut, and Grulke, Eds., John Wiley & Sons (4th Ed., 1999)).

In some embodiments, for coating applications, the particle size of the chiral material is less than about 25 microns, for example, less than about 10 microns, or less than about 5 microns. However, in some instances in chiral filled materials, larger or smaller particles are employed.

In certain embodiments, particles of chirally selective polymer-based materials are swollen in a swelling solvent, thus increasing pore or channel size. The degree of swelling in the material is controlled by the osmotic pressure and chemical potential of the solvent inside it. The open framework of pores or channels in the swollen material permits diffusion of large molecules, such as organometallic catalysts and biological enzymes, into the interior of the chiral material. In certain embodiments, diffusion is thus used to load catalytic molecules into the material. Once a desired concentration of catalytic molecules is reached, pore or channel size is reduced by drying the material or changing the swelling solvent, effectively trapping the catalytic molecules inside. Pore or channel sizes sufficient to limit diffusion of the catalytic molecules out of the material are still large enough not to perturb the geometry of the catalytic molecule.

A chiral enzyme or chiral catalyst for a polymerization may experience enhanced chiral selectivity in the chiral environment inside the chirally selective material, due to chirally differentiated constraints on the diffusion and reorientation modes of reactants. Different activated states of reactants and different conformational states of a chiral catalyst are expected to be preferentially stabilized in an environment with chiral physical features on the lengthscale of a molecule, when compared to a more symmetric environment. The chiral environment also may cause a chemically achiral catalyst molecule to exhibit chirally biased catalytic activity.

The chiral volumes inside chiral materials according to certain embodiments also are suitable for use as microscale and nanoscale reactive and non-reactive processing volumes, where flow rates of different species through the material provide kinetic control of processes and/or reactions. Kinetic “flow through” control provides processing and performance advantages even where the chiral volumes are too large, or the curvature too small, to significantly bias the chirality of the reaction.

Chiral materials prepared according to one or more embodiments herein also are useful as molds or masks to create new materials, such as oxides, with an inverse mask structure in three dimensions. These new materials, made using the original chiral materials as masks or molds, are solid wherever the originals were porous, and porous wherever the originals were solid. The new materials possess chiral nanostructure and/or microstructure with controlled feature sizes. In many cases, the chiral features are within a few orders of magnitude of a small molecule. New materials derived this way are useful as material-based chiral selectors and reaction environments.

The following non-limiting examples further illustrate certain embodiments.

### Example 1

### Preparation of Chirally Selective Powder from Bombyx Silk

Sericin-free silk from a Bombyx genus silk source was obtained using conventional methods, such as heating at 100° C. in 0.2 M Na₂CO₃. Sericin-free silk fibers (67 g) were combined with 40.2 ml of 5 N HCl and 67 g of NaCl in 1340 ml tap water. The mixture was heated to about 80° C. during mixing, and then the temperature was held at 90-95° C. The fibers sat on the surface of the solution, then started to wet. As the fibers wet, they began to sink, and stirring was started at this point. The mixture was stirred at high speed for one hour. After one hour the mixture was cooled to room temperature.

The cooled mixture was first filtered through a 1000 μm sieve to remove the large particulates, if needed, and then filtered through a 150 μm sieve to separate smaller particles of dirt from the protein particles. The swelling solution was neutralized with 10% Na₂CO₃ solution until the pH reached 6-7, and then the particles were washed with water. In this procedure, 1 g silk protein was washed with 25 ml water. This mixture was stirred at room temperature for 5 minutes, filtered, and then a change of the washing water was added with more stirring. The steps of stirring, filtration, and washing were repeated three times, until the conductivity of the water fell to 600 mHo (conductivity of tap water) and stabilized. Then further wash cycles were performed using deionized (DI) water, with the same ratio of silk to water as for the tap water. Washing was continued until the conductivity of the wash water after washing was about 25-50 mHo (conductivity of DI water), typically three wash cycles. A final washing step was performed with 2-propanol.

The chiral material was filtered, placed into reusable dishes, dried at room temperature overnight, and then dried in a vacuum oven for one hour at 55° C. The material was cooled down in a desiccator at room temperature overnight, and then sieved to sort the particles.

### Example 2

### Preparation of Chirally Selective Powder from Antheraea Silk

Sericin-free silk fibers from an Antheraea silk source were obtained using conventional methods, such as heating at 100° C. in 0.2 M Na₂CO₃. Sericin-free silk (67 g) was combined with 40.2 ml of 5 N HCl and 67 g of NaCl in 670 ml tap water at 80° C. The temperature then was held at 90-95° C. The fibers sat on the surface of the solution, then started to wet. As the fibers wet, they began to sink, and stirring was started at this point. The mixture was stirred at high speed for one hour. After one hour, the mixture was cooled to room temperature.

The cooled mixture was first filtered through a 1000 μm sieve to remove the large particulates, if needed, and then filtered through a 150 μm sieve to separate smaller particles of dirt from the protein particles. The swelling solution was neutralized with 10% Na₂CO₃ solution until the pH reached 6-7, and then the particles were washed with water. In this procedure, 1 g silk protein was washed with 25 ml water. This mixture was stirred at room temperature for 5 minutes, filtered, and then a change of the washing water was added with more stirring. The steps of stirring, filtering, and washing were repeated three times, until the conductivity of the water fell to 600 mHo (conductivity of tap water) and stabilized. Further wash cycles were then performed using DI water, at the same ratio of silk to water as for the tap water. Washing was performed until the conductivity of the wash water after washing was about 25-50 mHo (conductivity of DI water), typically three wash cycles. A final washing step was performed with 2-propanol, a chiral solvent.

The chiral material was filtered, placed into reusable dishes, dried at room temperature overnight, and then dried in a vacuum oven for one hour at 55° C. The material was cooled down in a desiccator at room temperature overnight, and then sieved to sort the particles.

### Example 3

### Stability of Chiral Silk Material in Different Solvents and pH Ranges

Material was prepared from Bombyx mori silk according to Example 1, with the following modifications. The silk material was washed by tap water until the wash water conductivity stabilized at 600 mHo. Washing was then continued with DI water until the conductivity of the wash water was about 25-50 mHo. Then the material was washed with fresh EtOH and dried.

Stability testing was performed to determine the pH at which the material thus formed begins to degrade in different common solvents. Since the material was made from a chiral polymer (silk), rotation signals above baseline were used to assay degradation. The material was measured twice, each time after stirring for 3 minutes. Small rotation artifacts were observed, which were attributed to particulate floating in the solvents. Different solvents gave different results.

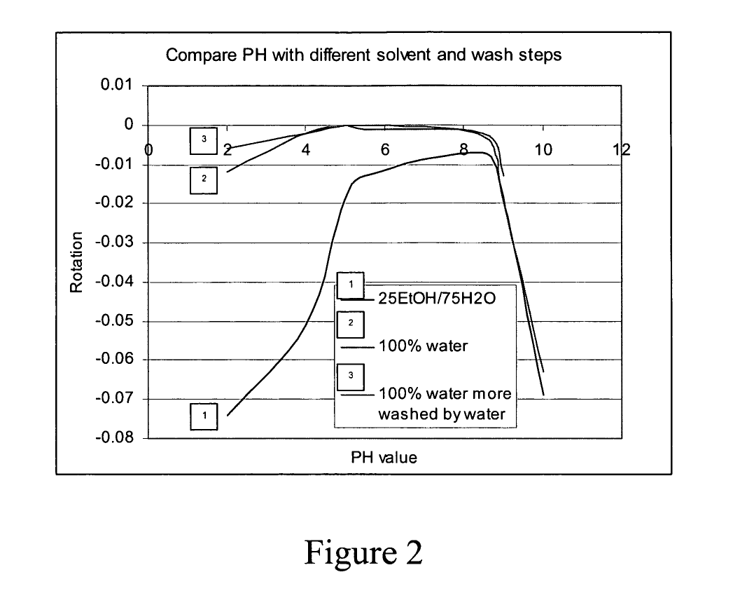

The results are reported in the plot shown in FIG. 2, and demonstrate that the material was very stable in 100% water, and not as stable in a mixed solvent system (25:75 ethanol:water). When washing progressed until a very clear wash liquid was obtained, water stability improved. It was observed that the material was stable in water over a pH range from 2 to 8.5. The material was not stable in the mixed solvent system of alcohol and water over this range. The range of stable pH was only from 5 to 8.5 in this solvent system.

### Example 4

### Method for Testing Chiral Selectivity

The stability of a chiral material is evaluated, and the material is tested for its chiral selectivity against a test sample containing more than one enantiomer. The test sample is either a racemic mixture or a mixture having less than 100% enantiomeric excess (EE) of one enantiomer.

First, the stability of the chiral material is determined by measuring the rotation of a clean non-chiral solvent that does not spontaneously rotate light before and after exposure to the material. The material is determined to be stable (no substantial sloughing of chiral molecules or particles from the material into the solvent) if the solvent light rotation is unchanged after exposure to the chiral material.

The chiral material is then tested against the test sample. The test sample is contacted with the chiral material under conditions, e.g., pH, under which the chiral material is stable. The chiral material typically is contacted with the test sample for 3-10 minutes. The chiral material is a dry powder or in solution. The test sample is a neat liquid, an oil, or a solution containing an enantiomeric mixture.

An exemplary test sample contains DL-lysine. After stability testing, the chiral material is tested against racemic DL-lysine, and the enantiomeric excess of the lysine remaining in solution is estimated from the starting concentration of lysine in solution, the observed rotation, and the standard rotation of lysine.

### Example 5

### Preparation of Crosslinked Protein Chiral Powder

A powder of chiral material was prepared according to Example 1. 2-propanol was used for the final washing step. The material was then crosslinked using poly(propylene glycol) diglycidyl ether (PGDE, CL-1) or citric acid (CL-2) as a crosslinking agent. 12 g of dry chiral material, 3.43 g of NaCl, 0.6 g of poly(propylene glycol) diglycidyl ether (PGDE) or citric acid (5% load of chemical crosslinker by weight), and 171.6 ml ethanol (EtOH) (or DI water) were reacted at 60° C., stirring for one hour. The material was filtered, put into reusable dishes, and dried in a hood at room temperature overnight. Then the material was dried in a vacuum oven for one hour at 55° C., and cooled down to room temperature in a desiccator. The powder was sieved when dry to obtain particle size fractions.

### Example 6

### Effects of Crosslinking on Stability

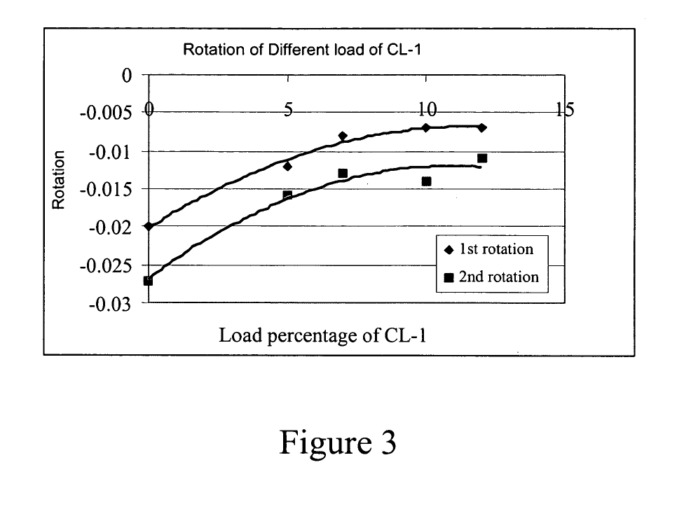

A series of crosslinked chiral protein powders were made as described in Example 5, except that the crosslinking agent PGDE (CL-1) was added in proportions ranging from 5% to 12% by weight (compared to the weight of the chiral material). The results are shown in Table 1 and FIG. 3. Chiral selectivity was determined using DL-lysine as the test sample, as described in Example 4.

TABLE 1
Rotation with different load percentages of crosslinking agent PGDE

| PGDE | 1st rotation | 2nd rotation |
|---|---|---|
| load % | (initial) | (after several min) |
| 0 | −0.020 | −0.027 |
| 5 | −0.012 | −0.016 |
| 7 | −0.008 | −0.013 |
| 10 | −0.007 | −0.014 |
| 12 | −0.007 | −0.011 |

Comparing the data in Table 1 and FIG. 3, when the loading of PGDE crosslinking agent is greater than 7%, the curve appears flat. Thus, the data suggest that at crosslinking agent loads of greater than 5%, no additional stabilization is achieved, and high chiral selectivity can be obtained even at 12% crosslinking agent.

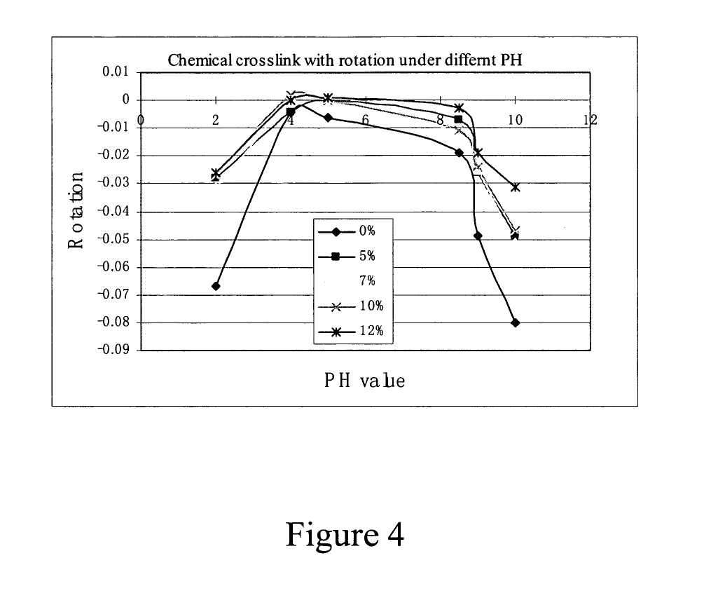

Table 2 and FIG. 4 compare the pH stability of materials prepared using different crosslinking agent load percentages, and show that at 12% loading of crosslinking agent, the material is stable over a pH range from 4 to 8.5.

TABLE 2
Rotation with different loads of PGDE crosslinking
agent under different pH conditions

| | 0% load | 5% load | 7% load | 10% load | 12% load |
|---|---|---|---|---|---|
| pH 2 | −0.067 | −0.028 | −0.031 | −0.027 | −0.026 |
| pH 4 | −0.004 | −0.004 | −0.001 | 0.002 | 0 |
| pH 5 | −0.006 | 0 | 0 | 0 | 0.001 |
| pH 8.5 | −0.019 | −0.007 | −0.012 | −0.011 | −0.003 |
| pH 9 | −0.049 | −0.026 | −0.025 | −0.024 | −0.019 |
| pH 10 | −0.080 | −0.049 | −0.051 | −0.047 | −0.031 |

### Example 7

### Effects of Crosslinking on Molecular Structure

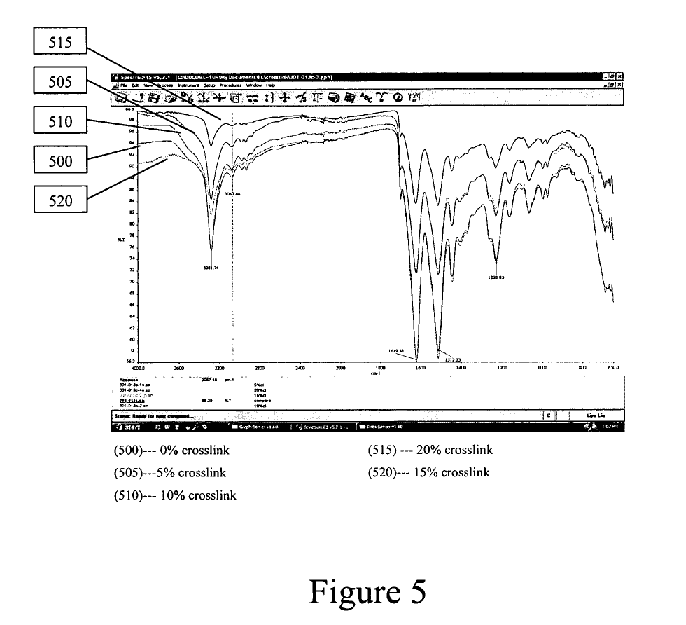

In order to determine the effect of crosslinking on materials structure, Fourier transform infrared (FTIR) spectroscopy was used to probe changes in chemical composition as crosslinking agent PGDE (CL-1) was added at varying loads. FIG. 5 shows the FTIR spectra of the chiral materials with crosslinking agent loads of 5% (505), 10% (510), 15% (515) and 20% (520), and a control without crosslinks (500).

FTIR can identify changes in molecular structure, as well as chemical changes. Molecular structure-dependent shifts in FTIR bands can be used to diagnose conformation in polymers, and are well-documented for proteins and polypeptides. In the crosslinking experiments, the secondary structure of the molecules of the chirally selective material was unchanged, as seen by the persistent strong bands at 1619, 1512, and 3281 wavenumbers. However, with the introduction of crosslinks, the lowest frequency region of the spectrum changed, and there was some loss of structure in the highest frequencies of the Amide A band, due to functional groups that should attach the crosslinks. These results indicate that the material can be crosslinked without wholesale disruption of the material structure.

### Example 8

### Chirally Selective Powder Made from Antheraea Pernyii Silk

A chiral material was prepared as described in Example 1, except that the silk source was Antheraea Pernyii, and the salts added for three different preparations were 1.0 N HCl (Al), 20% CaCO₃/1N HCl (A2), and 9.3 M LBr/5.0 N HCl (A3). The resultant powder was tested for chiral selectivity. The experiments were performed in 1:1 ethanol:water using 4-hydroxymandelic acid monohydrate (HMA). The results are shown in Table 3.

TABLE 3
Antheraea Pernyii

| | A3 | | | A1 | | | A2 | | |
|---|---|---|---|---|---|---|---|---|---|
| HMA | | 0.06075 | | | 0.0600 | | | 0.02055 | |
| (g) | | | | | | | | | |
| Solvent | 4 | 4 | | 4 | 4 | | 3 | 3 | |
| (ml) | | | | | | | | | |
| Room | | 0.002 | | | 0.002 | | | 0.002 | |
| temp. | | | | | | | | | |
| Rotation | | | | | | | | | |
| Powder | 0.3007 | 0.30098 | | 0.30018 | 0.30076 | | 0.10018 | 0.10075 | |
| (g) | | | | | | | | | |
| | Rotation | | Change | Rotation | | Change | Rotation | | Change |
| | Day 1 | | | Day 1 | | | Day 1 | | |
| 1 min. | 0.002 | 0 | −0.002 | 0.002 | 0.002 | 0 | 0.002 | 0.002 | 0 |
| R.T. | | | | | | | | | |
| 20 min. | 0 | −0.003 | −0.003 | −0.001 | −0.004 | −0.003 | −0.001 | 0.001 | 0.002 |
| R.T | | | | | | | | | |
| 40 min. | 0.002 | −0.004 | −0.006 | −0.002 | −0.003 | −0.001 | −0.001 | 0.002 | 0.003 |
| R.T | | | | | | | | | |
| 60 min. | 0.002 | −0.004 | −0.006 | −0.002 | −0.003 | −0.001 | −0.001 | 0.002 | 0.003 |
| R.T | | | | | | | | | |
| | Day 2 | | | Day 4 | | | Day 4 | | |
| Next day | 0.002 | −0.006 | −0.008 | −0.002 | −0.003 | −0.001 | −0.002 | 0.002 | 0.004 |
| | cm | | | cm | | | cm | | |
| | Day 1 | | | Day 1 | | | Day 1 | | |
| Dry | 0.5 | 0.5 | | 0.6 | | | 0.4 | | |
| powder | | | | | | | | | |
| Wet | 0.8 | 0.9 | | 0.9 | 0.95 | | 0.5 | 0.5 | |
| powder | | | | | | | | | |
| | Day 2 | | | Day 4 | | | Day 4 | | |
| Wet | 0.8 | 0.9 | | 0.9 | 0.95 | | 0.5 | 0.5 | |
| powder | | | | | | | | | |

Rotation testing was performed using racemic DL-methoxy mandelic acid (MMA) in solution with chiral material made from Antheraea Pernyii silk. The silk was prepared by adding a salt and slowly heating the protein fibers to soften them until a powder was formed. The salts were designated A1-A3. All of the material variants shown demonstrated chiral selectivity against MMA. The results for three preparations with A2 are shown in Table 4.

TABLE 4
Chiral selectivity of Antheraea Pernyii-based material
against DL-methoxy mandelic acid

| | 1 | | | 2 | | | 3 | | |
|---|---|---|---|---|---|---|---|---|---|
| MMA (g) | | 0.06 | | | 0.0602 | | | 0.0606 | |
| Solvent (ml) | | 4 | | | 4 | | | 4 | |
| Room temp. | | 0.001 | | | 0.001 | | | 0.001 | |
| Rotation | | | | | | | | | |
| Powder (g) | 0.3000 | 0.3003 | | 0.3000 | 0.3004 | | 0.3005 | 0.3001 | |
| | Rotation | | change | Rotation | | change | Rotation | | change |
| | Day 1 | | | Day 1 | | | Day 1 | | |
| 1 min. R.T. | 0.001 | −0.007 | −0.008 | 0.002 | −0.007 | −0.009 | 0.002 | −0.004 | −0.006 |
| 20 min. R.T | 0.002 | −0.012 | −0.014 | 0.002 | −0.011 | −0.013 | 0.002 | −0.008 | −0.010 |
| 40 min. R.T | 0.002 | −0.014 | −0.016 | 0.002 | −0.013 | −0.015 | 0.002 | −0.007 | −0.009 |
| | Day 4 | | | Day 4 | | | Day 4 | | |
| Next day | 0.002 | −0.015 | −0.017 | 0.002 | −0.013 | −0.015 | 0.002 | −0.008 | −0.010 |
| | cm | | | cm | | | cm | | |
| | Day 1 | | | Day 1 | | | Day 1 | | |
| Dry powder | 0.70 | | | 0.70 | | | 0.70 | | |
| Wet powder | 0.85 | 1.1 | | 0.90 | 1.0 | | 0.90 | 1.0 | |
| | Day 4 | | | Day 4 | | | Day 4 | | |
| Wet powder | 0.90 | 1.1 | | 0.90 | 1.0 | | 0.90 | 1.0 | |

### Example 9

### Comparison of Chiral Selectivity of Starting Silk Fiber and Processed Chiral Powder

The high chiral selectivities observed in materials made as described herein are based on the supermolecular structure, rather than the chemistry or natural structure of the chiral molecules and chiral materials used to make them. To test this, the raw material B. Mori silk fiber used to make a chiral material of high chiral selectivity was tested for chiral selectivity using the same test procedure as for the final chirally selective material.

As an additional control, protein powder was precipitated from silk fiber solubilized using the solubulizing process believed to produce the most selective templated materials, by adding a strong precipitant and collecting the resulting precipitate. This additional control produced a material with no special morphology or structure, yet made from the same molecules (chemistry) as the silk fiber raw material, and the same molecules (chemistry) as the highly selective chiral materials described herein. The precipitate was a powder with a particle size similar to the highly selective chiral material powders prepared using the disclosed methodology. A powder-to-powder comparison was expected to be closer than comparing dense, low surface area fibers to powder particles of lower density and higher surface area.

Experiments were performed to test the selectivity of as-received clean B. mori fibers, prior to processing. Additional experiments were performed to test the selectivity of semicrystalline and amorphous protein precipitates from solution. Racemic lysine was used as a selectivity probe, because the chirally selective materials prepared using the disclosed methodology have a high chiral selectivity and affinity for lysine, with the affinity being based on molecular chemistry. Since the underlying molecules and chemistry were the same for all three types of material (high chiral selectivity powder, precipitate powder, and fiber), all three were presumed to have very similar affinities for lysine. However, if chiral selectivity is indeed based on the microscale and nanoscale shape induced in the materials, as described in the present disclosure, the three different materials would demonstrate different chirally selective uptake of lysine.

A solution was prepared using 0.06 g racemic lysine in 2 ml pure water. A baseline was established by measuring the rotation of the lysine solution prior to exposure to the test materials. A test sample was prepared by placing 0.3 g test silk material into a clean glass vial. For each test, a control was run in parallel, prepared by placing 0.3 g test material into a clean glass vial. Two ml racemic lysine solution (for which a rotation baseline had been obtained) was introduced into the test vial. Two ml solvent (pure water) was introduced into the control. Both test and control vials were then sealed and agitated.

To test chiral lysine uptake, the liquid was removed from each vial after a period of shaking, and centrifuged to settle any particulates. Centrifugation of fine particulates ensured that chiral material did not pass through the optical path during measurement and create a false chiral signal. The clear centrifuged lysine solution was measured with polarimetry, as was the clear control solution. These values were obtained after 1, 10, and 30 minutes, and 1 day of exposure to each material.

The test and control signals observed for both precipitates and chopped fibers were below the noise level of the instrument, indicating a near zero % EE in the lysine outside the materials, and very low (not measurable) chiral selectivity in lysine uptake. In contrast, the chirally selective materials made as described in the present disclosure, having the identical chemistry and molecular composition, produced lysine solutions with very high rotations from these tests. Control data were similar to the fiber and precipitate examples. The high chiral selectivity powders (not precipitated) excluded predominantly the (−) or D isomer of lysine, and readily absorbed L-lysine, resulting in a solution of 40-100% EE of D-lysine outside the material at the end of the controlled experiment.

### Example 10

### Packing Chiral Protein Powder in Separations Column

Material such as was prepared in Example 1 was slurried using isopropanol or hexane, and pumped into a pre-column reservoir at 4000 to 8000 psi. The columns were packed with particles of different sizes, for example, 5 to 25 microns or 25 microns and smaller. The reservoir was connected to an empty column casing 5 to 25 cm long and 0.3 to 2 cm in diameter (inner diameter). When the column was full, the sealed column could typically be used in normal phase HPLC. When the material had been treated to stabilize it against swelling by water (for example, by crosslinking or hydrophobic surface coating with, e.g., hexamethyl disilane (HMDS)), up to 10% water could be used in HPLC analyses and purifications. For columns to be used in aqueous solvent, the particles can be pre-swollen in water prior to packing.

In one experiment, a chiral protein powder prepared as described in Example 5 using 5% PGDE (CL-1) crosslinking agent, and having a particle size of less than 25 μm, was used to prepare an HPLC column. The Lab Alliance Model CP column packing instrument was used, with slurry packing. The columns were 4.6 mm (inner diameter)×25 cm (length), stainless steel. Ethanol was used as the packing solvent. 3.0 g of powder was diluted with 20 ml ethanol to form a slurry. The pump was set to a flow rate cutoff of 12 ml/min and a pressure of 500 psi. After 5 min the pressure was increased to 1000 psi and held for 5 min. The pressure was incrementally increased by 500 psi until 3000 psi, and then decreased by the same intervals. When this column was put on an HPLC, the resulting pressure was 353 psi when flowing 1.0 ml/minute of mobile phase of 100% ethanol. The pressure on the column with a mobile phase of 90:10 hexane:ethanol was 104 psi.

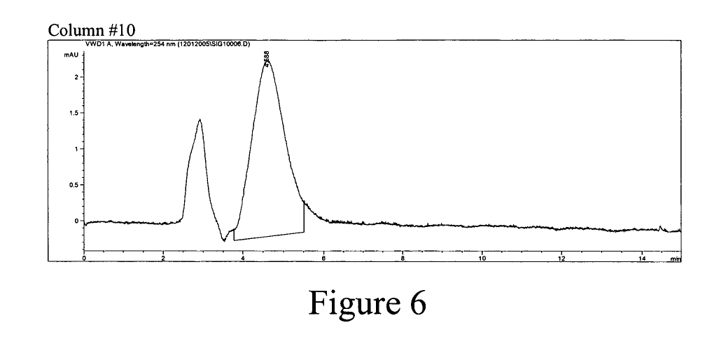

Columns were tested using thalidomide and demonstrated effective separation of the two enantiomers. An exemplary elution is shown in FIG. 6.

### Example 11

### HPLC Separations

HPLC separations have been performed for chemical classes previously thought difficult or impossible to resolve by liquid chromatography.

A 4.6 mm×250 mm HPLC column was packed with powder prepared as described in Example 1. A solvent system of 88:10:2 hexanes:tetrahydrofuran:isopropanol was employed, with a flow rate of 0.5 ml/min, a pressure of 14 bar, and a running time of 30 min.

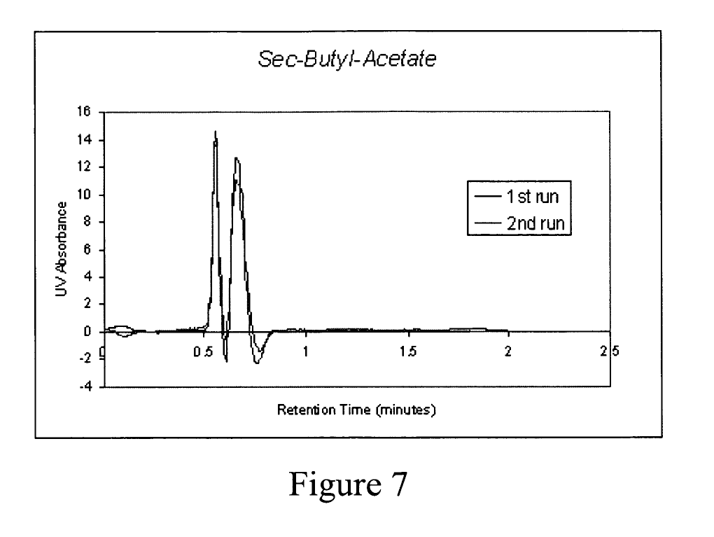

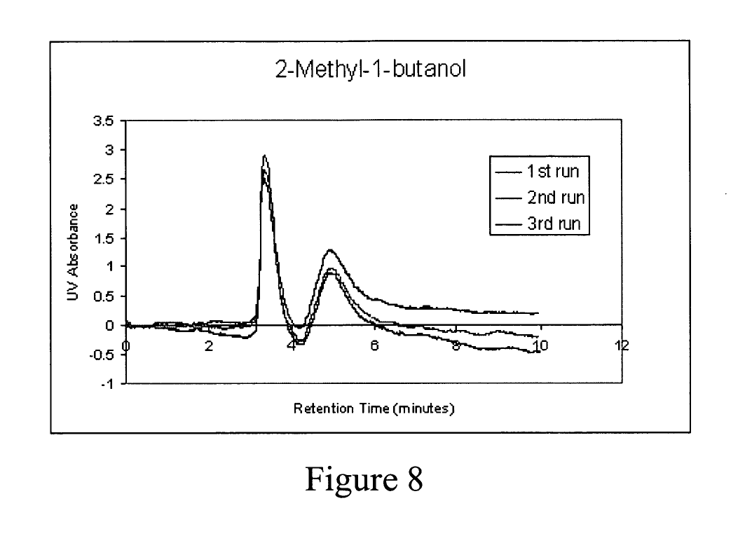

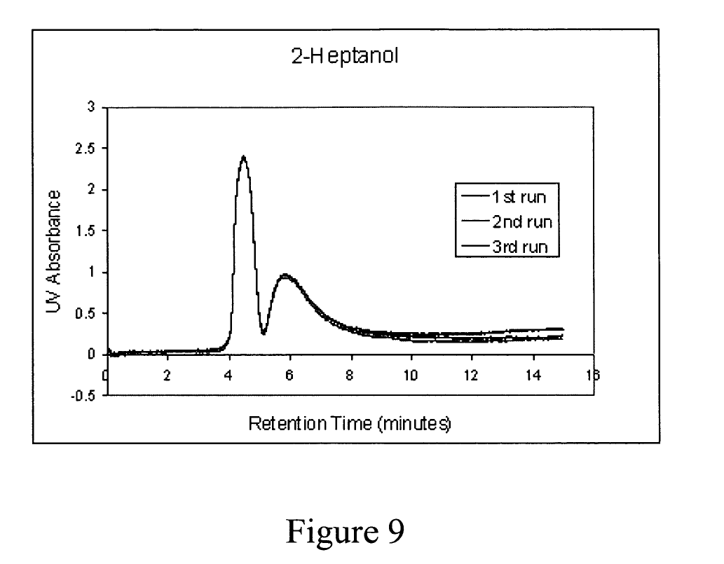

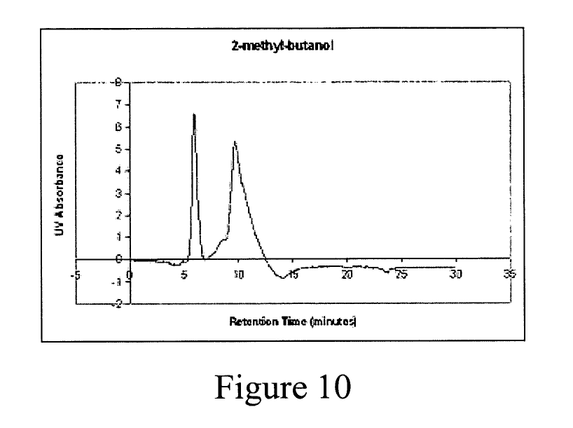

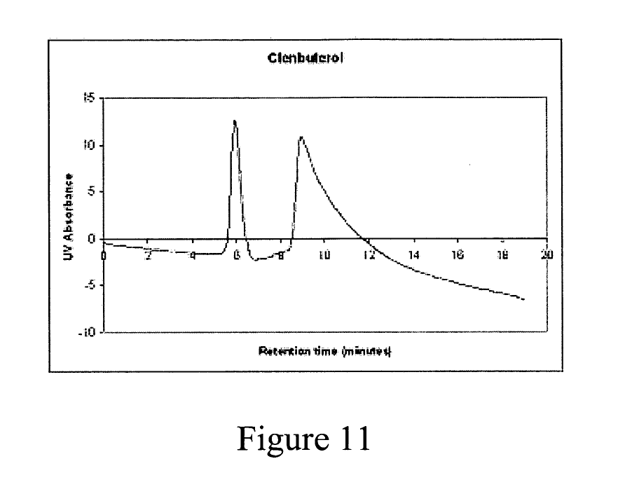

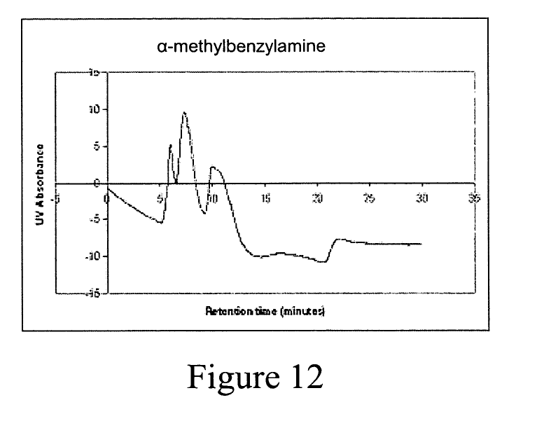

Separation of the compounds sec-butyl acetate, 2-methyl-1-butanol, 2-heptanol, 2-methyl-butanol, clenbuterol and α-methylbenzylamine is illustrated in FIGS. 7-12, respectively.

### Example 12

### Chiral HPLC of Camphor

An HPLC column, 25 cm×1 cm (0.5 cm inner diameter), was packed with chiral material made according to Example 1. The material was crosslinked using a 5 weight % loading of PGDE. The particles were sorted to obtain a size fraction between 5 and 25 microns using a sonicating sifter. The powder was slurry packed into the column at 4000 psi using isopropanol to generate the slurry. A normal phase column was obtained, suitable for chiral separations at the analytical scale. Different UV wavelengths were used to detect the separation, in order to find a wavelength where the compound of interest had a strong absorption above the noise from solvent refractive index and small impurities in the sample.

Separation of a sample of camphor was obtained using a mobile phase of 90:10 hexanes:ethanol, a flow rate of 0.5 ml/min, a pressure of 75 bar, a running time of 20 min, and an injection volume of 5 μl. UV monitoring was performed at 210, 230, 254, and 280 nm.

### Example 13

### Comparison of Crosslinked and Uncrosslinked Columns

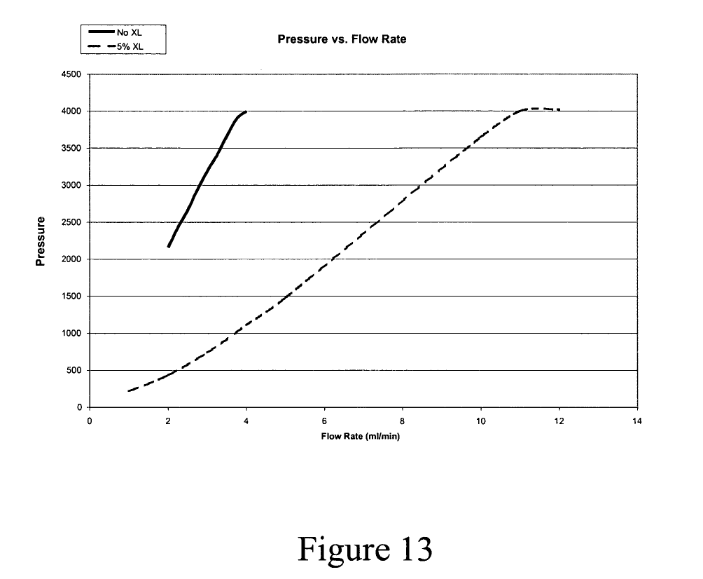

Columns were packed with particles of chirally selective material less than 25 microns in size. Particles of material crosslinked with 5 wt % crosslinking agent were compared with particles of uncrosslinked material. The uncrosslinked material formed a less compressible slurry, as shown in FIG. 13. In both sets of particles, difficulties were experienced removing the smallest particles (less than 5 microns) from the fraction. Different quantities and distributions of these small particles in the crosslinked and uncrosslinked samples may have contributed to the observed compressibility differences.

### Example 14

### Selectivity of a Column in HPLC and Super Critical Fluid Chromatography (SFC)

An HPLC column, 25 cm×1 cm (0.5 cm inner diameter), was packed with particles of chiral material made according to Example 1, using Bombyx silk from China. The material was crosslinked using a 5 weight % loading of PGDE. Particles were sorted to obtain a size fraction between 5 and 25 microns using a sonicating sifter. The powder was slurry packed into the column at 4000 psi using isopropanol to generate the slurry. A normal phase column was obtained, suitable for chiral separations at the analytical scale.

A number of analytes were screened on the column to determine selectivity (evidence of separation, without developing methods for a baseline separation). HPLC results were obtained first, and then the column was switched to SFC. After the SFC studies were completed, the column was switched back to HPLC, and rinsed thoroughly with HPLC solvent to re-equilibrate.

Selectivity results were obtained with HPLC for clenbuterol hydrochloride, ionone, salbutanol, HMMA (hydroxy methyl mandelic acid), catechin, Troger's Base, tryptophan, 2-pentanol, 2-methyl-2,4-pentane diol, 2-methyl-1-propanol, 2-butanol and 3-butyn-2-ol. Selectivity results were obtained with SFC for DL-histidine, DL-lysine, DL-α-ionone, vanilmendelic acid, DL-phenyl-glycine hydrochloride, thalidomide, hydroxy mandelic acid (HMA), 2-methyl-2,4-pentane diol, camphor, and 2-butanol. Separation with SFC was achieved for DL-tryptophan and DL-phenylalanine, for which a method producing baseline separations had been developed for the column in prior experiments.

After the column had been tested on both HPLC and SFC and then re-equilibrated for HPLC, compounds with baseline separation methods were retested on the column. No degradation in the separation or in the other column performance factors (pressure, flow rate, baseline stability) was noted. The results are shown in Table 5.

TABLE 5

| | | Lys. | | | |
|---|---|---|---|---|---|
| Analyte | Solvent | EE % | Score | Rotation | pH |
| DL-histidine | EtOH:H₂O | 99.2 | Some separation | −0.032 | 6 |
| | (0.5:3.5) | | | | |
| DL-camphor | EtOH:H₂O | 99.2 | Some separation | −0.013 | 6 |
| | (50:50) | | | | |
| Hydroxy | MeOH:H₂O | 99.2 | Some separation | −0.024 | 6 |
| phenylglycine | (3.5:0.5) | | | | |
| methyl ester | | | | | |
| hydrochloride | | | | | |
| α-ionone | MeOH:H₂O | 99.2 | No separation | 0.004 | 6 |
| | (3.5:0.5) | | | | |
| DL-methionine | EtOH:H₂O | 99.2 | No separation | −0.007 | 6 |
| | (0.5:3.5) | | | | |
| α-phellandrene | Neat | 99.2 | Good separation | 0.38 | 6 |
| 2-methyl- | EtOH:H₂O | 100 | Good separation | −0.024 | 8.5 |
| benzylamine | (1.5:1.5) | | | | |

### Example 15

### Low Pressure Liquid Chromatography of Propargylic Alcohols

Chirally selective material was packed into a glass low pressure LC column, coupled with a peristaltic pump and Shodex® OR-1 optical rotation detector. 1:1 ethanol:water was used as a mobile phase, with diluted DL-HMMA (hydroxy methoxy mandelic acid) as the analyte. The rotation of the fluid leaving the column was measured using the in-line Shodex® OR-1 detector. 22 fractions from this run were collected for examination off-line. After about 7 minutes, there was still nothing observed on the rotation detector, but significant signals were seen on a UV spectrometer from the corresponding collected fractions. About a 1.2 ml delay was calculated between the OR-1 detector and the collection outlet.

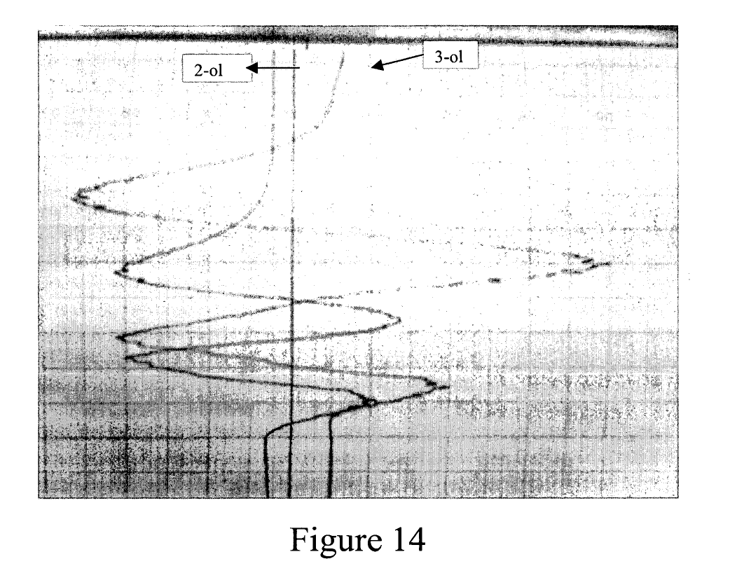

Diluted 3-butyn-2-ol and 1-hexyn-3-ol were then used as analytes in this column, and fractions were collected. FIG. 14 shows the rotation versus time observed on the in-line Shodex® detector for both analytes. 15 fractions were collected from these runs for off-line analysis. These fractions were diluted and double-checked with the off-line polarimeter. Although rotation was seen in situ in the OR-1 detector, no rotation was seen on the off-line polarimeter, possibly due to the very low concentration of the analyte in the diluted fractions.

### Example 16

### Batch Sorbent Separation of α-Methyl Benzylamine

α-methyl benzylamine (0.0049 g) was prepared in 3 ml of a solvent system including ethanol, DI water, and/or pH 5 buffer (phosphate in DI water). The first rotation measurement was taken after α-methyl benzylamine was fully dissolved in the solvent system. 0.2 g chirally selective powder was added to the solution containing α-methyl benzylamine, and stirred for 3 minutes, after which the sample was centrifuged for 30 minutes. After centrifugation, the rotation of the supernatant liquid was again measured (second rotation). The third rotation was taken after the stirring and centrifugation steps were repeated. The pH was controlled to achieve the same pH value in the solvent mixtures. The chiral material was stable over a pH range from 4 to 9. Thus, as pure α-methyl benzylamine is quite basic (pH=14), solutions were prepared with pH values less than 9.

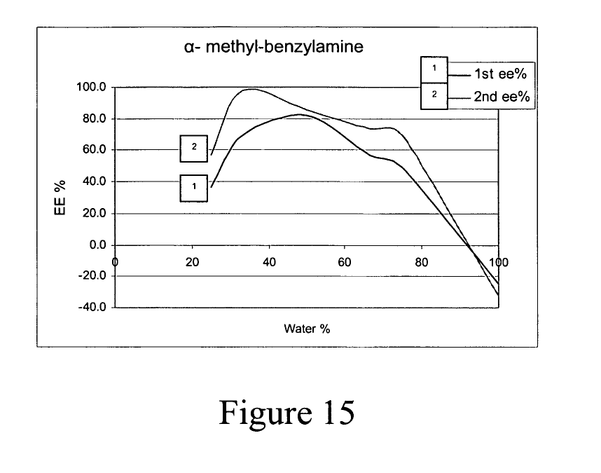

A plot of EE % obtained using different ratios of water to ethanol is shown in FIG. 15. As shown in FIG. 15, 81.33% EE was obtained after the first cycle of stirring in a 50:50 water:EtOH solvent system. In a 33% water solvent system, 97.96% EE was obtained after the second stirring cycle. When 100% water was used, a positive rotation was observed, suggesting a switch in the material's chiral selectivity.

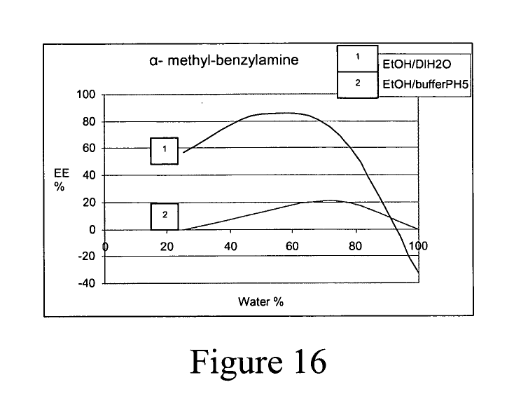

The experiment was repeated in a pH 5 buffer solution. Results are shown in FIG. 16, illustrating a drop in EE for the buffered solution.

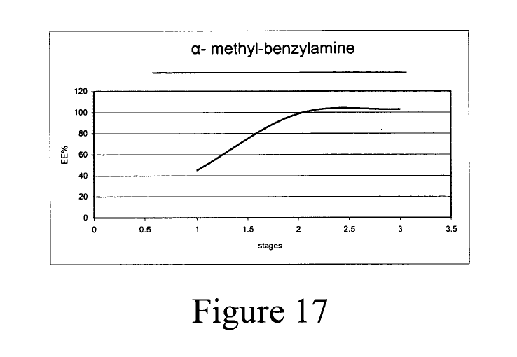

In order to determine how many batch sorbent separation stages were required to get 100% EE, a series of batch sorbent experiments were performed, with new chirally selective material being added after each stage, i.e., each repetition of the stirring, centrifugation, and filtration steps. 98.7% EE was obtained after the second batch sorbent stage, and 100% EE was obtained after the third stage. Additional stirring time increased the EE per stage. The results are reported in FIG. 17.

These studies showed that α-methyl benzylamine was easily separated by the chirally selective material used as a batch sorbent, and that water and ethanol were a good solvent system for this purpose, but that pH 5 buffer solution was not good for chiral separation in this case. It was also seen that 100% chiral separation was obtained in approximately three sorbent stages. With a longer stirring time, only two sorbent stages were required.

### Example 17

### Batch Sorbent Separation of 3-Butyn-2-Ol

A batch sorbent separation was performed on 3-butyn-2-ol (CH₃CHOHCCH). Different solvent ratios of ethanol:water were tested. A. Pernyii silk was used as the starting material to prepare the chirally selective powder (B. mori silk was determined not to work on this compound for batch sorbent separation).

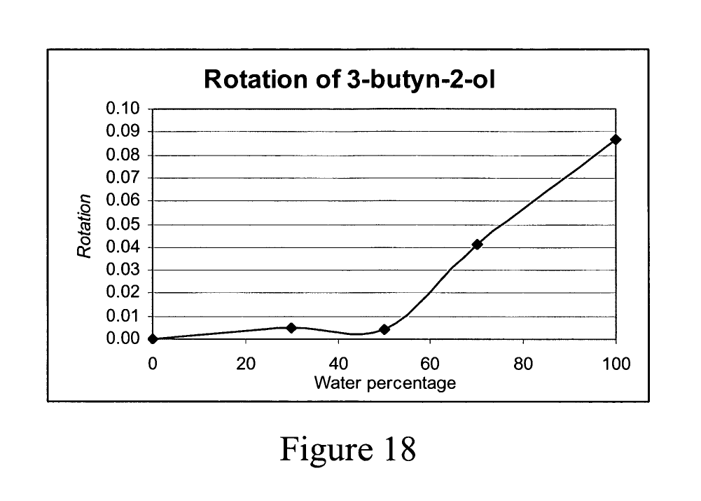

The results, reported in FIG. 18, show that when more water was used in the solvent system, better chiral separation of 3-butyn-2-ol was obtained. The highest rotation was obtained in 100% water.

As will be apparent to one of ordinary skill in the art from a reading of this disclosure, the present invention can be embodied in forms other than those specifically disclosed above. The particular embodiments described above are, therefore, to be considered as illustrative and not restrictive. The scope of the invention is as set forth in the appended claims, rather than being limited to the examples contained in the foregoing description.

What is claimed is:

1. A method for producing a chiral particulate material, the method comprising:
(a) exposing a fibrous protein or chiral synthetic polymer to an aqueous solution containing a swelling agent to swell the fibrous protein or chiral synthetic polymer;
(b) annealing the swollen fibrous protein or chiral synthetic polymer in the aqueous solution to obtain a liquid crystalline ordered solid creating a multilayered structure defining an interlayer region including chiral pores or channels;
(c) removing the swelling agent; and
(d) recovering a chiral particulate material.

2. The method of claim 1, wherein the chiral pores or channels have a diameter between about 5 nm and about 50 nm.

3. The method of claim 1, wherein the fibrous protein or chiral synthetic polymer has an aspect ratio greater than about 3:1.

4. The method of claim 1, wherein the chiral particulate material has an aspect ratio of about 2:1 to about 1:1.

5. The method of claim 1, wherein annealing is carried out for at least about 4 hours.

6. The method of claim 1, wherein annealing is carried out for about 1 hour to about 6 hours.

7. The method of claim 1, further comprising curing the chiral particulate material to stabilize the structure of the material.

8. The method of claim 7, wherein curing comprises heating the particulate material in an aqueous solution substantially free of swelling agent for at least about three hours.

9. The method of claim 7, wherein curing is performed for about 3 hours to about 48 hours.

10. The method of claim 7, wherein curing comprises heating the particulate material in an alcohol solution substantially free of swelling agent for at least about three hours.

11. The method of claim 1, further comprising crosslinking the chiral particulate material.

12. The method of claim 1, further comprising exchanging the aqueous solvent within the interior of the chiral material with a second solvent.

13. The method of claim 1, further comprising introducing a catalyst into the interior of the chiral material.

14. A chiral separations column comprising closely packed particles of a fibrous protein liquid crystalline ordered solid having a multilayered structure, wherein each layer comprises a molecularly oriented fibrous protein, and wherein the layers define an interlayer region including chiral pores or channels, wherein the chiral pores or channels are selective to one chiral orientation and have a diameter between about 5 nm and about 50 nm.

15. The column of claim 14, wherein the particles are substantially uniform, rounded particles.

16. The column of claim 14, wherein the particles have a size of about 5 microns to about 25 microns.

17. The column of claim 14, wherein the column provides a separation efficiency greater than about 10% EE.

18. The column of claim 14, wherein the particles are crosslinked.

19. The column of claim 14, wherein the particles are swollen in a solvent.

20. A chiral particulate material comprising substantially uniform rounded particles of a fibrous protein liquid crystalline ordered solid having a multilayered structure, wherein each layer comprises a molecularly oriented fibrous protein, and wherein the layers define an interlayer region including chiral pores or channels having a diameter between about 5 nm and about 50 nm.

21. The material of claim 20, wherein the material is crosslinked.

22. The material of claim 21, wherein the crosslink comprises about 1 wt % to about 20 wt % of the chiral material.

23. The material of claim 21, wherein the crosslink comprises about 5 wt % of the chiral material.

24. The material of claim 21, wherein the crosslink density is selected to reduce swelling of the particulate material in water.

25. The material of claim 20, wherein the accessible surface area of the material possesses a chiral submicron texture.

26. A separations column containing particles of the material of claim 20.

27. A chiral HPLC column capable of producing baseline resolution chromatographs for enantiomers of one or more of 2-heptanol, 2-methyl-1-butanol, 2-pentanol, 2-butanol, 2-amino-1-butanol, 2-amino-1-pentanol, 3-butyn-2-ol, phellandrene, fluoxetine, thalidomide, alkaloids and terpenes.

28. The column of claim 27, wherein the column is capable of resolving structural isomers and/or diastereomers of one or more of 2-heptanol, 2-methyl-1-butanol, 2-pentanol, 2-butanol, 2-amino-1-butanol, 2-amino-1-pentanol, 3-butyn-2-ol, phellandrene, fluoxetine, thalidomide, alkaloids and terpenes.

29. The column of claim 27, wherein the column is capable of resolving enantiomers having multiple chiral centers.
